(19) United States
(12) Patent Application Publication
(10) Pub. No.: US 2017/0269728 A1
(43) Pub. Date: Sep. 21, 2017

(54) RHOMBIC MESH ELECTRODE MATRIX HAVING PERIODIC ELECTRODES

(71) Applicant: Microsoft Technology Licensing, LLC, Redmond, WA (US)

(72) Inventor: Sean M. Donnelly, Portland, OR (US)

(73) Assignee: Microsoft Technology Licensing, LLC, Redmond, WA (US)

(21) Appl. No.: 15/070,992

(22) Filed: Mar. 15, 2016

(51) Int. Cl. G06F 3/044

(52) U.S. Cl. CPC G06F 3/044; G06F 2203/04112; G06F 2203/04111

(57) ABSTRACT

An electrode matrix comprises two orthogonal periodic arrays of mesh electrodes, in which each array comprises an opaque, electrically conductive periodic mesh divided by gaps into a plurality of electrodes. The meshes of the two arrays use an identical rhombus-shaped unit cell, with the unit cell of the first array arranged interstitially to that of the second array. The lengths of the diagonals of the unit cell are chosen to simultaneously minimize the visibility of moiré interactions with a particular display device, and to provide a geometric relationship between the electrode boundaries and the mesh that exactly repeats over a small-integer number of electrodes.

### BACKGROUND

Capacitive touch sensors may comprise a matrix of electrically conducting column and row electrodes, each electrode comprised of an opaque metal electrode mesh. Applying such sensors to large format displays may require hundreds of electrodes and tens of millions of mesh elements forming unique electrode geometries. Further, any superposition of two or more unlike periodic structures, or of identical periodic structures having a relative angular displacement, will produce perceptible moiré patterns.

### BRIEF DESCRIPTION OF THE DRAWINGS

FIG. 1 is a perspective view of a large format multi-touch display device in accordance with one embodiment of the present disclosure.

FIG. 2 is a cross-sectional view of an optical stack for a capacitive touch-sensing display of the large format multi-touch display device of FIG. 1.

FIG. 3 shows a schematic top view of a metal mesh for a transmit electrode array and a metal mesh for a receive electrode array that are overlaid on a pixel array.

FIG. 4 shows a schematic top view of a rhombic lattice mesh for a transmit electrode array and a rhombic lattice mesh for a receive electrode array that are overlaid on a pixel array.

FIG. 5A shows a schematic top view of unit cells of a first rhombic lattice mesh that are interstitial to unit cells of a second rhombic lattice mesh.

FIG. 5B shows a schematic top view of unit cells of a first rhombic lattice mesh that are substantially interstitial to unit cells of a second rhombic lattice mesh.

FIG. 6A shows a schematic top view of a first array of electrodes and a second array of electrodes for a capacitive touch sensor.

FIG. 6B shows a schematic top view of the first array of electrodes and second array of electrodes depicted in FIG. 6A including a rhombic lattice mesh for the first electrode array.

FIG. 6C shows a schematic top view of the first array of electrodes and a second array of electrodes depicted in FIG. 6A including a rhombic lattice mesh for the second electrode array.

FIG. 6D shows a schematic top view of a rhombic electrode matrix comprising the rhombic lattice meshes of FIGS. 6A and 6B overlaid on a pixel array.

FIG. 7A shows a schematic top view of a first array of electrodes and a second array of electrodes for a capacitive touch sensor.

FIG. 7B shows a schematic top view of the first array of electrodes and second array of electrodes depicted in FIG. 7A including a rhombic lattice mesh for the first electrode array.

FIG. 7C shows a schematic top view of the first array of electrodes and a second array of electrodes depicted in FIG. 7A including a rhombic lattice mesh for the second electrode array.

FIG. 7D shows a schematic top view of a rhombic electrode matrix comprising the rhombic lattice meshes of FIGS. 7A and 7B overlaid on a pixel array.

FIG. 8A shows a schematic top view of first electrode array and a second electrode array.

FIG. 8B shows a schematic top of the first array of electrodes and second array of electrodes depicted in FIG. 8A including a rhombic lattice mesh for the first electrode array.

FIG. 8C shows a schematic top view of the first array of electrodes and a second array of electrodes depicted in FIG. 8A including a rhombic lattice mesh for the second electrode array.

FIG. 8D shows a schematic top view of a rhombic electrode matrix comprising the rhombic lattice meshes of FIGS. 8A and 9B overlaid on a pixel array.

FIG. 9A schematically shows a portion of a periodic mesh having a rhombic unit cell and mesh openings with rounded vertices.

FIG. 9B schematically shows a portion of a periodic mesh having a rhombic unit cell and curvilinear mesh openings.

FIG. 10 is a schematic view of an image source for the display device of FIG. 1.

### DETAILED DESCRIPTION

Metal mesh electrodes are presently favored for capacitive touch sensors in large capacitive touch-sensing display devices. However, any superposition of two or more unlike periodic structures, or of identical periodic structures having a relative angular displacement, will produce moiré patterns. Touch displays incorporating meshes having a periodic, or nearly periodic, structure may thus produce moiré effects that can be distracting to the user. Particularly in large scale touch displays (e.g. 0.5 meters or greater in extent), where the display subtends a major fraction of the user's visual field, moirés may be made significantly more distracting by parallax-induced apparent motion because portions of the display are often within the user's peripheral vision field, which has higher sensitivity to apparent motion than does the central foveal vision field.

Several techniques have been used to minimize the perceptibility of moirés metal-mesh touch display systems. In one example, the width of the mesh conductors may be reduced. The spatial frequencies of the moirés remain unchanged, but their optical contrasts are reduced, making them less perceptible to users. However, the spatial resolution of available fabrication methods imposes a lower limit on conductor width. Narrower conductors also increase the electrical resistance of the electrodes, which, particularly in large touch displays, may limit the touch sensor's sensitivity or temporal resolution. Further, as display resolution increases moiré contrast is also increased. As each pixel becomes smaller, a greater fraction of its area is occluded by a conductor of a given line width.

The shape, spatial frequency, and optical contrast of each moiré is determined by the spatial periods of the structures, the shapes and sizes of the periodic elements, and the displacements between the structures. Thus, for a given display device, the visibility of such moiré effects is strongly dependent upon the spacing and directions of periodicity of the meth openings. In most cases, the choice of these parameters is narrowly constrained by the need to minimize moiré visibility. The pattern of mesh openings must be oriented at specific oblique angles relative to the columns and rows of display pixels, with the openings spaced apart by specific non-integer multiples of the pixel pitch. As most capacitive touch sensors incorporate two or more mesh electrode arrays, the shape and patterns of mesh openings of each array must thus be chosen to prevent both mesh-on-mesh moirés and mesh-on-pixel moirés.

An electrode array comprising a periodic mesh is generally divided by gaps into a periodic array of electrically isolated electrodes, such that each electrode interrupts the mesh in a geometrically unique manner. Each adjacent electrode may be separated by an inter-electrode region and/or inter-electrode alley. Because variations in display occlusion are readily visible to users as unwanted luminance contrasts, it is desirable that the metal mesh fill not only the electrodes (electrode mesh), but also the inter-electrode regions (alley mesh). Even where the mesh lines are too small for users to visually resolve, users may more easily perceive the electrode boundaries unless the lines comprising the alley meshes are aligned with those of the electrode meshes. This generally requires that all electrodes and inter-electrode regions in one plane of the touch sensor be derived from a continuous mesh covering the entire display, interrupted by small gaps along the boundaries of the electrodes and within the alley mesh to provide electrical isolation.

Some manufacturers fabricate tooling for touch sensors in which the geometric relationship between the electrode boundary and the mesh is unique for each electrode. The design and tooling of such electrode arrays becomes increasingly complex as the number of electrodes increases, and may not be practical for large format displays comprising dozens of electrodes. Electrode-to-electrode variations in the geometric relationship between electrode boundary and mesh may cause additional functional problems, even in the case of a finite repeat length. For example, such variations cause adjacent electrodes to differ slightly in both total conductor area and shape of fringing electrical fields, and thus in capacitance relative to other conductors. This introduces node-to-node variations in the baseline capacitance of a mutual-capacitance touch sensor, which may then require compensation via more complex signal processing. The design complexity is greatly increased even further in the case of reentrant electrode shapes, such as a linked-diamond shape, which is commonly used to increase the sensitivity of capacitive touch sensors. For this reason, it is desirable for there to be a finite number of unique electrodes that repeat across the display. In an ideal case, each electrode in the array would be exactly identical (i.e. the electrode repeat length is equal to the electrode pitch).

This disclosure describes a muesli electrode matrix, such as might be used in a touch sensing display device, which provides a uniform visual appearance, minimal moiré interaction with pixelated displays, and a geometric relationship between the mesh and the electrode boundaries that exactly repeats over a small-integer number of electrodes.

The electrode matrix comprises two arrays of electrodes, each array comprising a periodic mesh of opaque electrically conductive material divided by gaps into a plurality of electrodes. The unit cell of each mesh is rhombic, meeting specific criteria for the relative lengths of its major and minor diagonals. The unit cells of the first mesh are arranged interstitially to the unit cells of the second mesh.

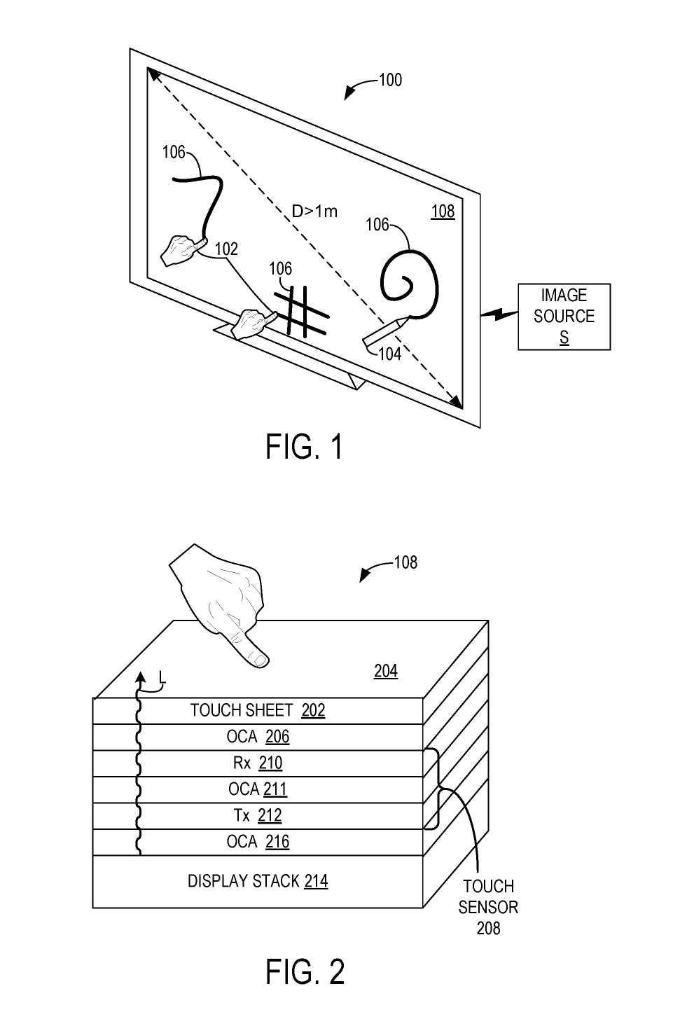

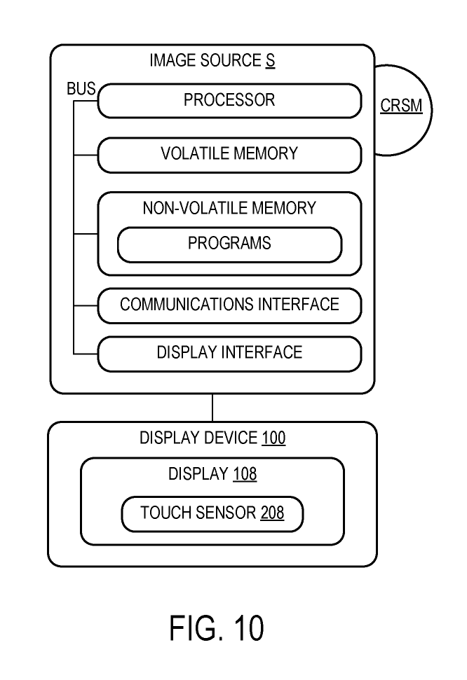

FIG. 1 shows a large format multi-touch display device 100 in accordance with an embodiment of the present disclosure. Display device 100 may have a diagonal dimension greater than 1 meter, for example. In other, particularly large-format embodiments, the diagonal dimension may be 55 inches or greater. Display device 100 may be configured to sense multiple sources of touch input, such as touch input applied by a digit 102 of a user or a stylus 104 manipulated by the user. Display device 100 may be connected to an e source S, such as an external computer or onboard processor. Image source S may receive multi-touch input from display device 100, process the multi-touch input, and produce appropriate graphical output 106 in response. Image source S is described in greater detail below reference to FIG. 10.

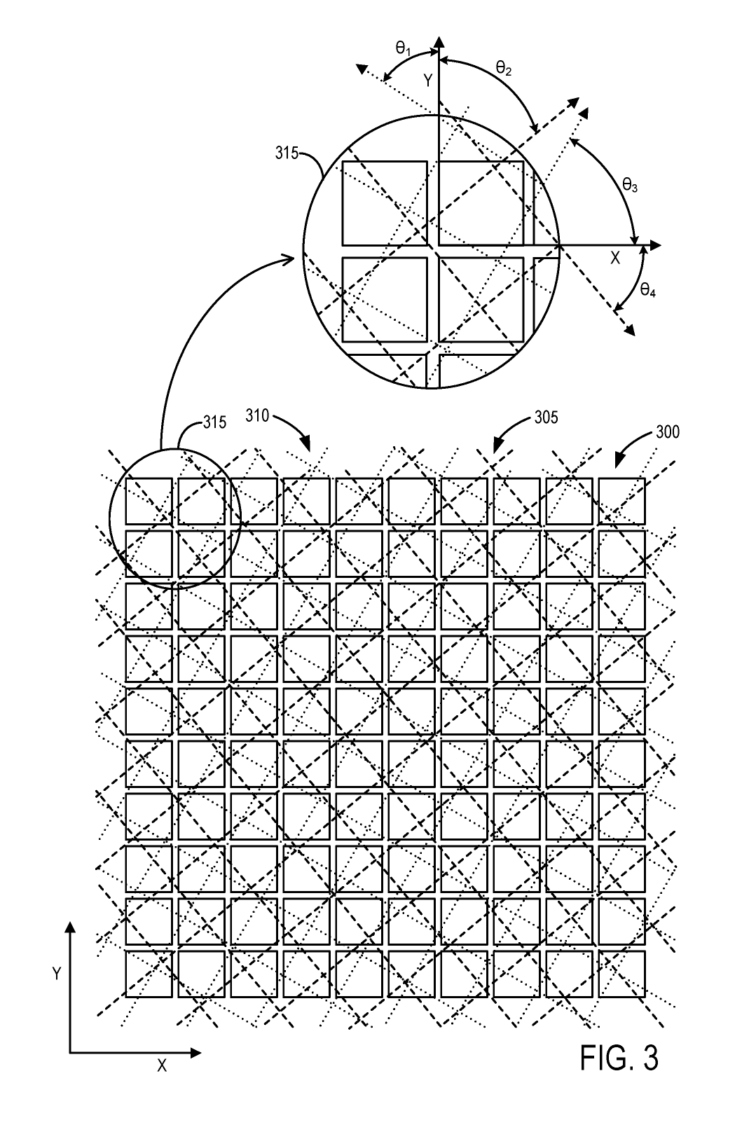

Display device 100 may include a capacitive touch-sensing display 108 to enable multi-touch sensing functionality. A schematic view of a partial cross section of an optical stack for capacitive touch-sensing display 108 is shown in FIG. 2. In this embodiment, capacitive touch-sensing display 108 includes an optically clear touch sheet 202 having a top surface 204 for receiving touch input, and an optically clear adhesive (OCA) layer 206 bonding a bottom surface of touch sheet 202 to a top surface of a touch sensor 208. Touch sheet 202 may be comprised of a suitable material, such as glass or plastic. Those of ordinary skill in the art will appreciate that optically clear adhesives refer to a class of adhesives that transmit and/or permit passage of substantially all (e.g., about 99%) of incident visible light.

As discussed in further detail below, touch sensor 208 is equipped with a matrix of electrodes comprising capacitive elements positioned a distance below touch sheet 202. As shown, the electrodes may be formed in two separate layers: a receive electrode layer 210 and a transmit electrode layer 212, which may each be formed on a transparent dielectric substrate comprising materials including but not limited to glass, polyethylene terephthalate (PET), polycarbonate (PC), or cyclic olefin polymer (COP) film.

In some embodiments, receive electrode layer 210 and transmit electrode layer 212 may be integrally formed as a single layer with electrodes arranged on opposite surfaces of insulating layer 211, which may be fabricated from an optically transparent, electrically insulating material. In other examples, receive and transmit electrode layers 210 and 212 may be formed on separate substrates. In such examples, insulating layer 211 may be an optically clear adhesive layer, such as an acrylic pressure-sensitive adhesive film, for example. Electrode layers 210 and 212 may thus be bonded together by insulating layer 211.

Electrode layers 210 and 212 may be formed by a variety of suitable processes. Such processes may include deposition of metallic wires onto the surface of an adhesive, dielectric substrate; patterned deposition of a material that selectively promotes the subsequent deposition of a metal film (e.g., via plating); photoetching; patterned deposition of a conductive ink (e.g., via inkjet, offset, relief, or intaglio printing); filling grooves in a dielectric substrate with conductive ink; selective optical exposure (e.g., through a mask or via laser writing) of an electrically conductive photoresist followed by chemical development to remove unexposed photoresist; and selective optical exposure of a silver halide emulsion followed by chemical development of the latent image to metallic silver, in turn followed by chemical fixing.

In one example, metalized sensor films may be disposed on a user-facing side of a substrate, with the metal facing away from the user or alternatively facing toward the user with a protective sheet (e.g., comprised of PET) between the user and metal. Although a transparent conductive oxide (TCO) (e.g., tin-doped indium oxide (ITO)) is typically not used in the electrodes, partial use of TCO to form a portion of the electrodes with other portions being formed of metal is possible. In one example, the electrodes may be thin metal of substantially constant cross section, and may be sized such that they may not be optically resolved and may thus be unobtrusive as seen from a perspective of a user. Suitable materials from which electrodes may be formed include various suitable metals (e.g., aluminum, copper, nickel, silver, gold), metallic alloys, conductive allotropes of carbon (e.g., graphite, fullerenes, amorphous carbon), conductive polymers, and conductive inks (e.g., made conductive via the addition of metal or carbon particles).

Receive electrode layer 210 may be designated a column electrode layer in which electrodes are at least partially aligned to a longitudinal axis (illustrated as a vertical axis), while transmit electrode layer 212 may be designated a row electrode layer in which electrodes are at least partially aligned to a lateral axis (illustrated as a horizontal axis). Such designation, however, is arbitrary and may be reversed. It will be appreciated that the vertical and horizontal axes depicted herein and other vertical and horizontal orientations are relative, and need not be defined relative to a fixed reference point (e.g., a point on Earth). To detect touch input, row electrodes may be successively driven with a time-varying voltage, while the column electrodes are held at ground and the current flowing into each column electrode is measured. The electrodes are configured to exhibit a change in capacitance of at least one of the capacitors in the matrix in response to a touch input on top surface 204. Capacitors may be formed, for example, at each intersection between a column electrode and a row electrode.

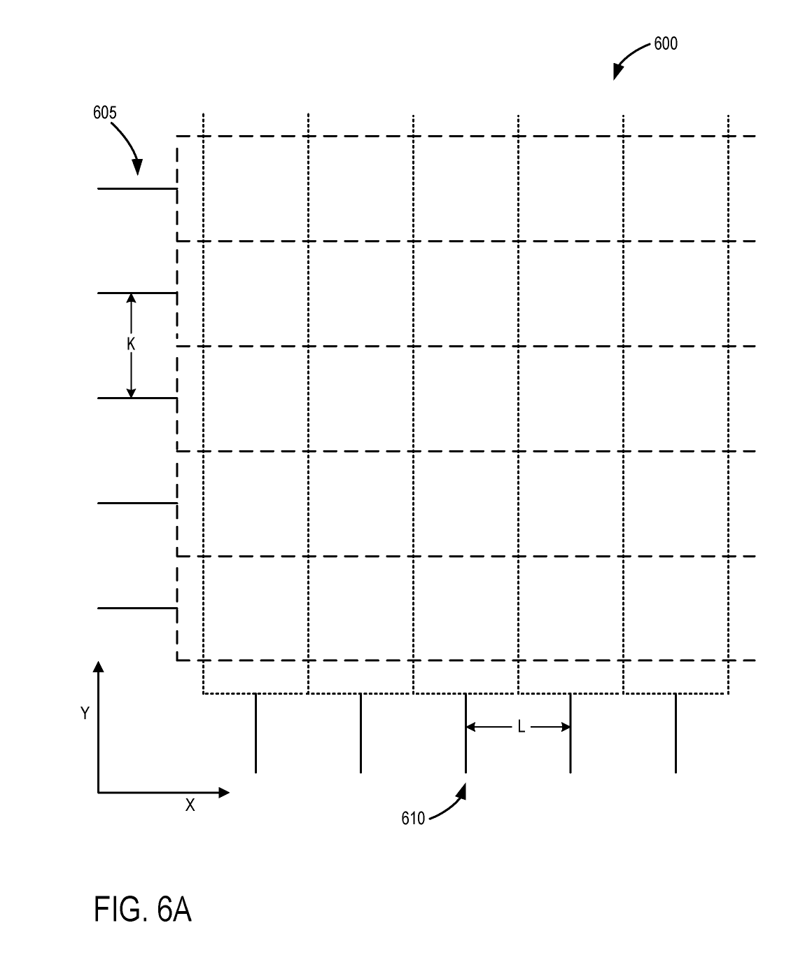

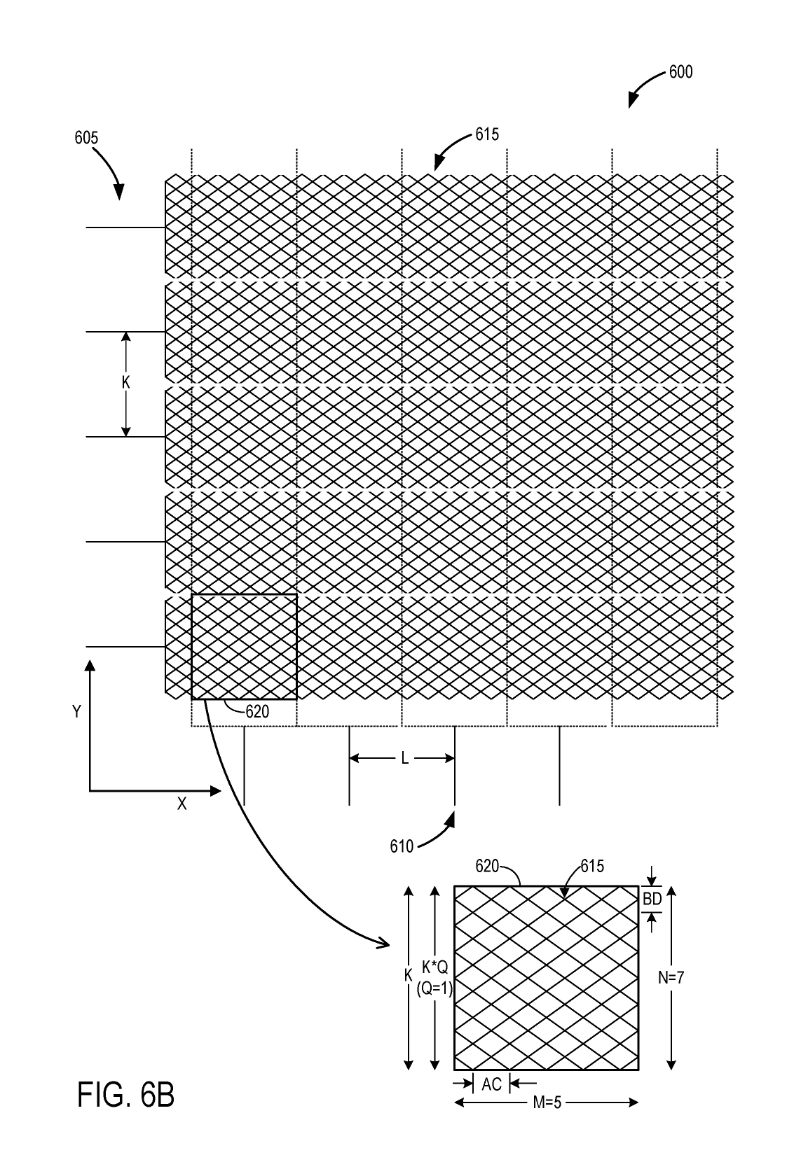

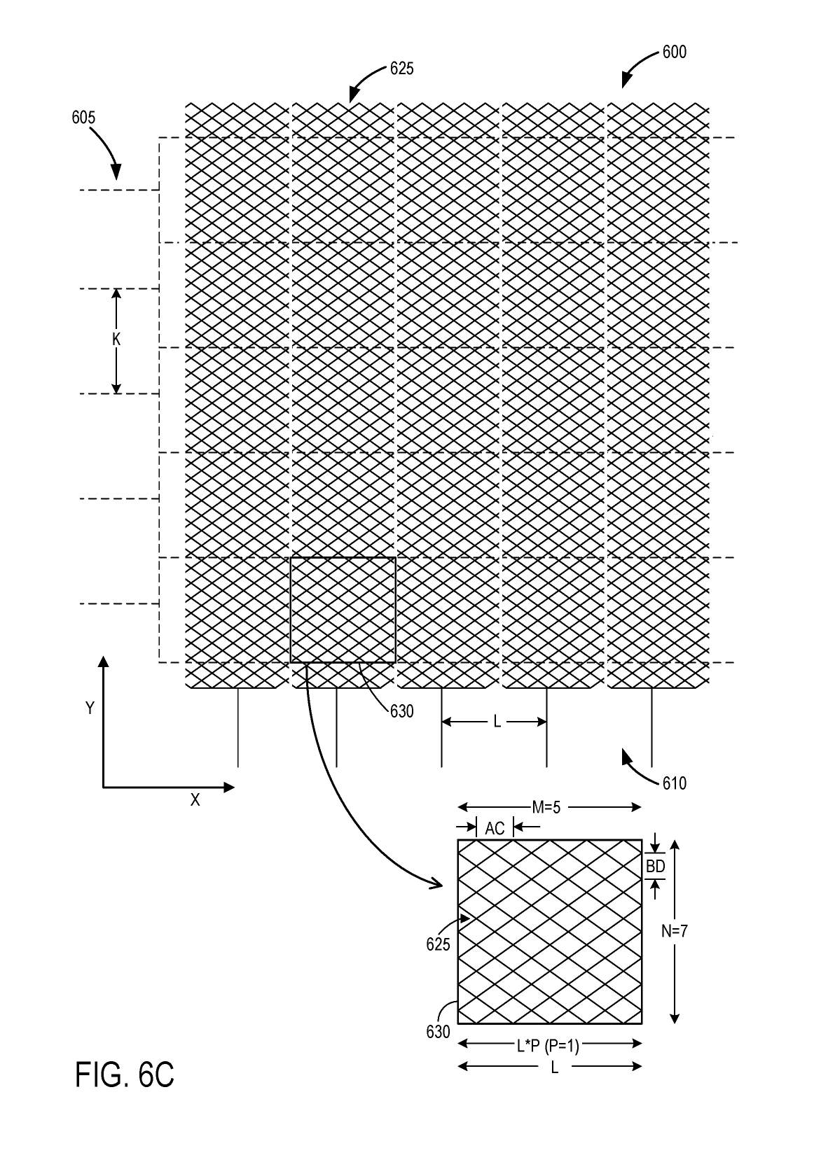

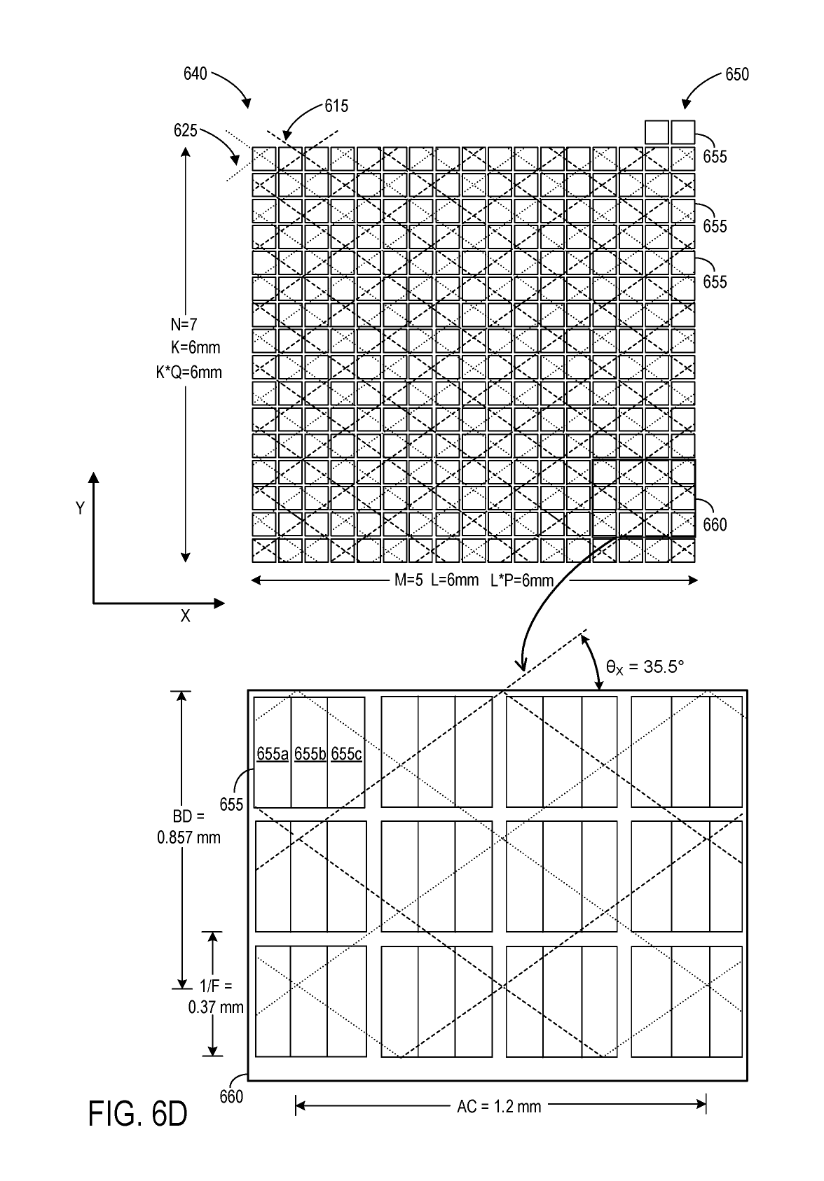

Changes in capacitance may be detected by a detection circuit as time-varying voltages are applied. Based on the time of detection and the degree of attenuation and/or phase shift in a measured current, the capacitance under test can be estimated and a row and column identified as corresponding to a touch input. The structure of the column and row electrodes is described in greater detail below with reference to FIGS. 6A-6D, 7A-7D, and 8A-8D.

Various aspects of touch sensor 208 may be selected to maximize the signal-to-noise ratio (SNR) of capacitance measurements and thus increase the quality of touch sensing. In one approach, the distance between the receive electrodes and a light-emitting display stack 214 is increased. This may be accomplished by increasing the thickness of insulating layer 211, for example, which may reduce the amount of electromagnetic noise reaching the receive electrodes. As non-limiting examples, the thickness of insulating layer 211 may be less than 1 mm and in some embodiments less than 0.2 mm. Additionally or alternatively, the electromagnetic noise reaching the receive electrodes may be decreased by increasing the thickness of optically clear adhesive layer 216. Moreover, the relative arrangement of column and row conductors maximizes the average distance between the column and row conductors in the plane of touch sensor 208—e.g., in a direction substantially perpendicular to a direction in which light L is emitted from a light-emitting display stack 214.

Continuing with FIG. 2, light-emitting display stack 214, which may be a liquid crystal display (LCD) stack, organic light-emitting diode (OLED) stack, plasma display panel (LCD), or other pixelated display stack is positioned below the electrode layers 210 and 212. An optically clear adhesive (OCA) layer 216 joins a bottom surface of transmit electrode layer 212 to a top surface of display stack 214. Display stack 214 is configured to emit light L through a top surface of the display stack, such that emitted light travels in a light emitting direction through layers 216, 212, 211, 210, 206, touch sheet 202, and out through top surface 204. In this way, emitted light may appear to a user as a displayed image on top surface 204 of touch sheet 202.

Touch sheet 202, OCA layer 206, insulating layer 211, and OCA layer 216 may comprise optically clear dielectric materials, such as glass, plastic, optically clear adhesive, air, etc. In some examples, insulating layer 211 and/or OCA layer 216 may be layers of air or other transparent gas. In such examples, touch sensor 208 may be considered to be air-gapped and optically uncoupled from display stack 214. Further, layers 210 and 212 may be laminated on top surface 204. Still further, layer 210 may be disposed on top surface 204 while layer 212 may be arranged opposite and below top surface 204.

The electrode matrix of a mutual-capacitance touch sensor is comprised of two orthogonal linear arrays of electrodes, one array operating as a set of transmit electrodes, the other as a set of receive electrodes. As shown in FIG. 2, these two arrays lie in two parallel planes separated by a transparent electrical insulator. One example method of construction is to fabricate each array of electrodes on its own transparent substrate, then laminate the two substrates together. If the unit cell of the mesh used in the transmit electrodes is identical to that of the receive electrodes, any misalignment between them can produce an objectionable moiré effect. For this reason, when accurate alignment cannot be assured, it is common to orient the unit cell of the transmit-electrode mesh obliquely to that of the receive-electrode mesh. Meshes having square unit cells facilitate making the periodicity directions of the display pixels, transmit-electrode mesh, and receive-electrode mesh all mutually oblique to each other at angles that minimize moiré interactions. This can also be accomplished with rectangular unit cells, however, square cells additionally allow the use of the most moiré-optimal spatial frequency in each axis.

U.S. patent application Ser. No. 14/569,502 discloses an electrode structure based on a periodic mesh having a square unit cell that is oriented obliquely to the rows and columns of the display's pixels. The spatial frequency and orientation of the meshes minimize the visibility of moiré effects for a given display pixel spatial frequency. Further, the geometric relationship between electrode boundary and mesh exactly repeats over a small-integer number of electrodes, based on a periodic mesh having a square unit cell that is oriented obliquely to the rows and columns of the display's pixels.

FIG. 3 shows an example of the use of oblique-square meshes to generate periodicity directions that are mutually oblique. FIG. 3 shows a schematic top view of a pixel array 300 (solid lines) overlaid with a metal mesh for a first electrode array 305 (dashed lines) and a metal mesh for a second electrode array 310 (dotted lines). Inset 315 shows a detailed view of a portion of pixel array 300, first electrode array 305, and second electrode array 310. Each electrode matrix is periodic in two orthogonal directions, such that each periodicity direction lies at an angle of θₙ with respect to adjacent periodicity directions. As shown, first electrode array 305 is periodic in a first direction that is offset from X by an angle of θ₄ and in a second direction that is offset from Y by an angle of θ₂. Second electrode array 310 is periodic in a first direction that is offset from X by an angle of θ₃ and in a second direction that is offset from Y by an angle of θ₁. First electrode array 305 and second electrode array 310 thus have periodicities that are offset by angles of {θ₁+θ₂} and {θ₃+θ₄}.

In such an example, the display pixels are arranged along X at a spatial frequency (F_{X}), while the conductors for each electrode matrix are arranged along X at a spatial frequency (G_{X}), each conductor intersecting X at an angle θ_{X}. The moirés produced by each periodic mesh superposed on the pixel array are most perceptible at or near particular points (singularities) in the {(F_{X}/(G_{X}*cos θ_{X})), tan(θ_{X})} parameter space. In particular, the pitch and optical contrast of moiré bands have local maxima at points that lie along tan (θ_{X})={0, 1/8, 1/7, 1/6, 1/5, 1/4, 1/3, 2/5, 1/2, 3/5, 2/3, 3/4, 4/5, 1} and are periodic in F_{X}/(G_{X}*cos (θ_{X})). The value of tan (θ_{X}) that globally minimizes the perceptibility of moirés is typically within the range of 1/2<tan(θ_{X})<4/5, and is not equal to 3/5, 2/3, or 3/4, and/or within 0.01 of 1/2, 3/5, 2/3, 3/4 or 4/5.

Recent improvements in the fabrication of metal-mesh electrodes have enabled both transmit and receive electrode arrays to be fabricated on opposite sides of a single transparent substrate with such high accuracy of relative alignment that there is no risk of moiré interaction between the two arrays. This allows the two electrode arrays to use geometrically congruent unit cells if the unit cells of the two arrays are arranged interstitially to each other, thus halving the number of parameters that must be optimized to minimize the visibility of moiré effects. The use of interstitial rhombus meshes generates identical periodicity directions for the transmit and receive electrodes, and thus allows for the periodicity directions of the electrode meshes to be oriented obliquely to the periodicity directions of an underlying pixel array at an optimal angle for minimizing mesh-on-pixel moirés.

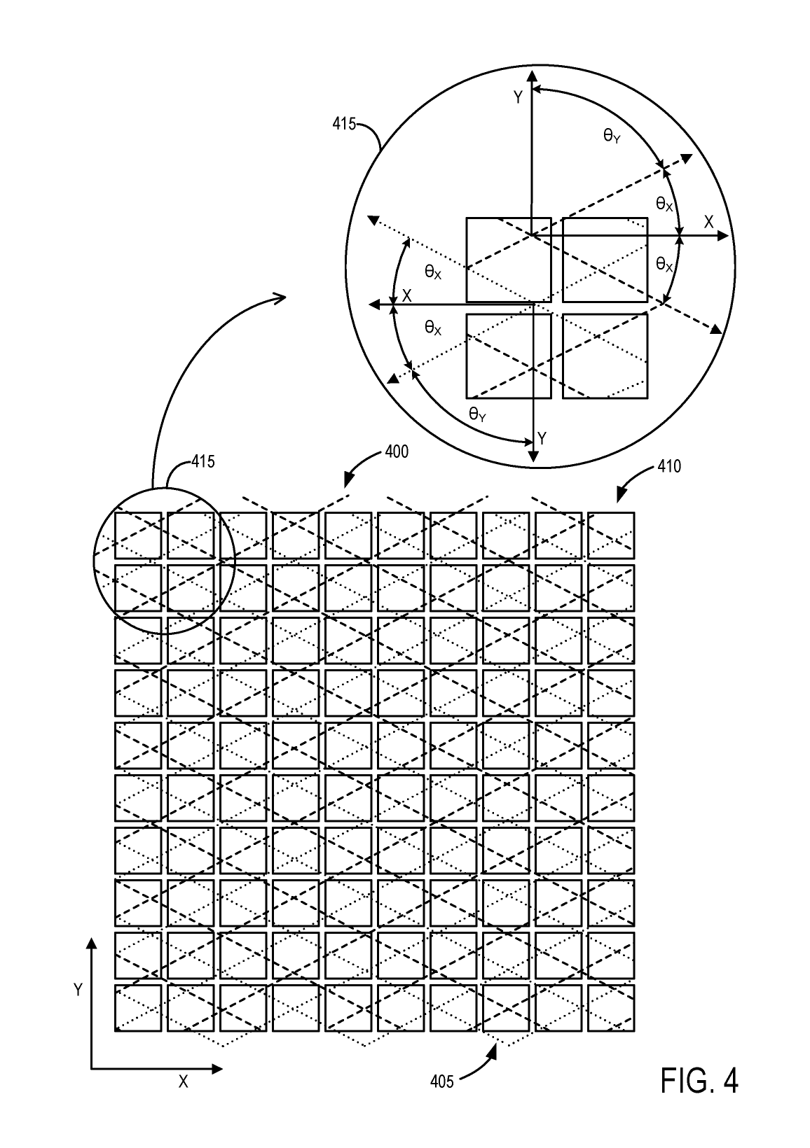

FIG. 4 shows a schematic top view of a rhombic lattice mesh for a first electrode array 400 (dashed lines) and a rhombic lattice mesh for a second electrode array 405 (dotted lines) that are overlaid on a pixel array 410. Pixel array 410 comprises a plurality of display pixels shown as squares (solid lines) arrayed along orthogonal directions X and Y. The rhombic lattice meshes of first electrode array 400 and second electrode array 405 are identical, and comprise, a rhombic unit cell with a major axis along X and a minor axis along Y. Further, as shown in inset 415, each unit cell of both first electrode array 400 and second electrode array 405 intersects with X at an angle θ_{X} and intersects with Y at an angle θ_{Y} (i.e., (90°−θ_{X})). The rhombic lattice meshes of first electrode array 400 and second electrode array 405 are each periodic in two directions which are displaced from Y by +θ_{Y} and −θ_{Y}.

When the unit cells of the two electrode arrays are arranged to be interstitial, the vertices of the unit cells of first electrode array 400 appear to be centered in the unit cells of second electrode array 405 when viewed from a direction normal to the XY plate. By arranging the unit cells interstitially in this manner, no moirés are generated by the superposition of the meshes of the first and second electrode arrays. By utilizing identical rhombic unit cells, moiré generation between the electrodes and underlying pixels may also be reduced, as this allows all of the conductors to be oriented at a single angle with respect to X and Y, and thus at a single angle with respect to the directions of pixel periodicity. As such, an optimal angle for moiré minimization with respect to X and Y may be determined for a given pixel array, and suitable rhombic lattice meshes ay be selected accordingly.

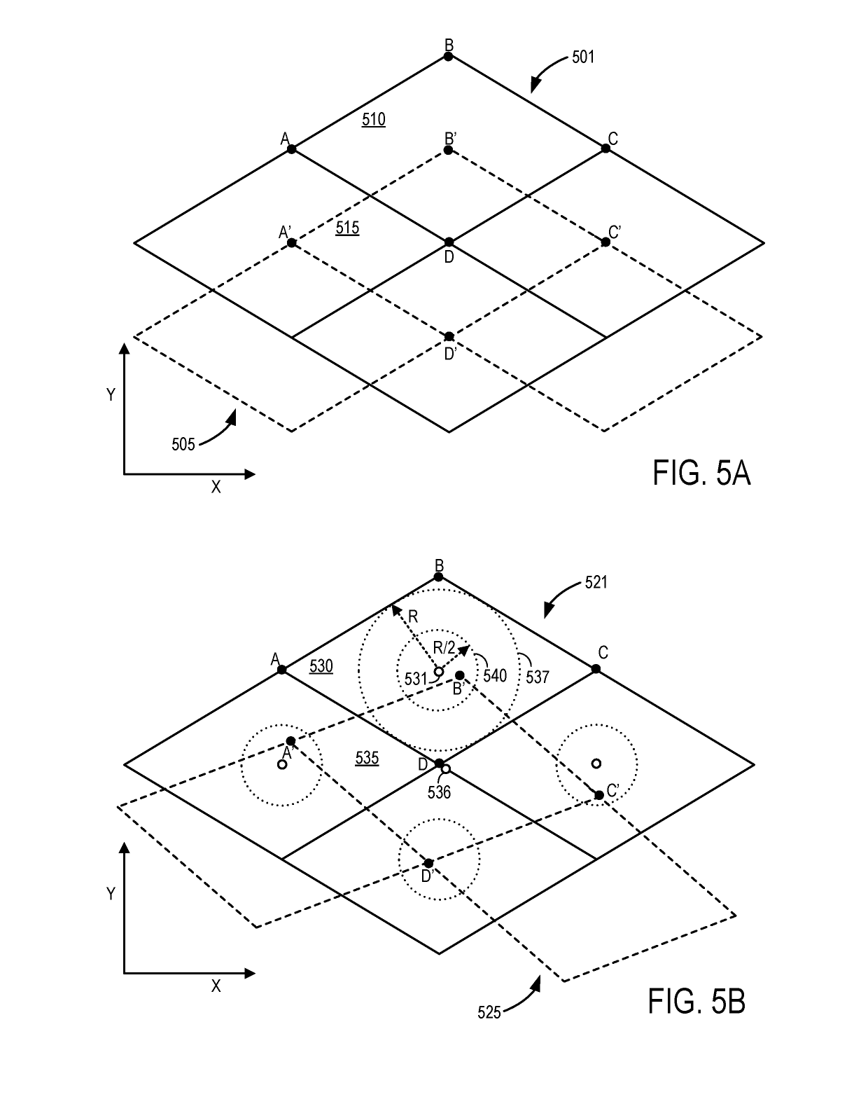

FIG. 5A shows the interstitial arrangement of two rhombic lattice meshes in greater detail. Unit cells of a first rhombic lattice mesh 501 (solid lines) are interstitial to unit cells of a second rhombic lattice mesh 503 (dashed lines). Unit cell 510 of first rhombic lattice mesh 501 comprises vertices A, B, C, and D. Unit cell 510 has a major axis AC and a minor axis BD, which are oriented along X and Y, respectively. Similarly, Unit cell 515 of second rhombic lattice mesh 505 comprises vertices A′, B′, C′, and D′, and comprises major axis A′C′ and minor axis B′D′, which are oriented along X and Y, respectively.

In a mutual-capacitance touch display, the transmit and receive electrodes typically extend along the same directions as the display pixel rows and columns, or vice versa, generally along orthogonal directions X and Y. In such examples, wherein major axis AC of unit cell ABCD is oriented along X, and minor axis BD is oriented along Y, θ_{X}, denoting the angle between any side of the unit cell and the X direction, is equal to arctan (BD/AC). The conductors in the mesh of each electrode are thus arrayed on pitch AC*sin(θ_{X}) along directions that are displaced from Y by θ_{Y}. With the unit cells for the electrode meshes of the transmit and receive electrodes arranged interstitially, the apparent spatial frequency (G_{X}) of conductors is equal to 2/(AC*sin(θ_{X}).

As shown in FIG. 5A, vertex B′ of unit cell 511 is coincident with the center of unit cell 510 (e.g., at the intersection of AC and BD). In practice, inaccuracy in the manufacturing of the two electrode arrays may result in modest rotation and translation of one array relative to the other. However, the technical effects of utilizing identical rhombic lattice meshes in the two layers of an electrode matrix are not limited to implementations wherein unit cells are precisely interstitial. As described further herein, moiré effects and optical contrast may be minimized by adjusting the ratio of the major and minor axis lengths to generate desired mesh periodicity along the X and Y directions. These parameters are valid for example electrode matrixes where the unit cells are substantially interstitial. Further, while this example and other examples herein are presented in the context of a pixel array having a square pixel and square unit cell, the use of interstitially arranged rhombic lattice meshes is equally applicable to pixel arrays having rectangular pixels and/or rectangular unit cells, as such a touch-sensing display device would also yield a singular value for θ_{X}.

As used herein, “substantially interstitial” refers to unit cells that are closer to being interstitial than to being coincident. In other words, when viewed from a direction normal to the electrode plane, the apparent distances between the vertices of the unit cells of the first array and the centers of the unit cells of the second array are less than the apparent distances between the vertices of the unit cells of the first array and corresponding vertices of the unit cells of the second array. However, if the unit cells are too coincident, the conductors may appear to be darker and/or thicker.

An example of substantially (e.g., not precisely) interstitial unit cells is shown in FIG. 5B. Unit cells of a first rhombic lattice mesh 521 (solid lines) are substantially interstitial to unit cells of a second rhombic lattice mesh 525 (dashed lines). Unit cell 530 of first rhombic lattice mesh 521 comprises vertices A, B, C, and D, with a center 531. Similarly, unit cell 535 of second rhombic lattice mesh 505 comprises vertices A′, B′, C′, and D′, with a center 536. In contrast with FIG. 5A, unit cell 535 is not precisely interstitial to unit cell 530. For example, vertex B′ is not coincident with center 531 of unit cell 530, and vertex D is not coincident with center 536 of unit cell 535.

Unit cell 530 is shown with inscribed circle 537 having a radius R, and an additional circle 540 centered at 531 having a radius R/2. Vertex B′ lies within circle 540, and vertexes A′, C′, and D′ also lie within a distance of R/2 from the centers of their respective interstitial unit cells of first rhombic lattice mesh 521. In this way, when viewed from a direction normal to the electrode plane, the apparent distances between the vertices of the unit cells of second rhombic lattice mesh 525 and the centers of the unit cells of the first rhombic lattice mesh 521 is less than one-half the radius of a circle inscribing the unit cell.

In the following examples, the display pixels may be assumed to be arrayed along orthogonal directions X and Y at spatial frequency F. Electrodes of the first array will be described as extending along X, while electrodes of the second array will be described as extending along Y. Electrodes of the first array may represent transmit electrodes, while electrodes of the second array may represent receive electrodes. However, such assignment is arbitrary, and may be interchanged within the scope of this disclosure. Further, the major and minor axes of the electrode mesh unit cells may also be assumed to extend along X and Y, though some tolerance for rotation of the unit cells is acceptable, as shown in FIG. 5B.

FIG. 6A schematically shows an example electrode matrix 600, comprising a first array of electrodes 605 and a second array electrodes 610. Five electrodes are shown as representative electrodes of each array out of the plurality of electrodes that snake up electrode matrix 600. Each adjacent electrode is electrically isolated via gaps (dashed lines). Electrodes of first array 605 extend along the X direction, and are arrayed along the Y direction on pitch K. Electrodes of second array 610 extend along the Y direction, and are arrayed along the X direction on pitch L. In this example, K=L. It is preferable for K and L to be similar, if not equal, in order to generate touch sensitivity that is consistent across the electrode matrix.

First electrode array 605 may comprise a repeating pattern of Q electrodes, thus generating a first electrode repeat length of K*Q, while second electrode array 610 may comprise a repeating pattern of P electrodes thus generating a second electrode repeat length L*P, where Q and P are integers. In small-format displays where the number of total electrodes is relatively small, such as a display for a smartphone, the electrodes may comprise a non-repeating pattern where no integer values exist for P and Q, or P and Q may be set to relatively high values so that the repeat lengths are equal to or greater than the length of the display. For large format displays, such as displays utilizing 120 or more electrodes in each direction, such strategies are impractical. Thus, P and Q are preferably relatively small integers, so that a small number of unique electrodes can be repeated across the display. In an ideal situation, P=Q=1. In other words, each electrode of first array 605 is identical and each electrode of second array 610 is identical.

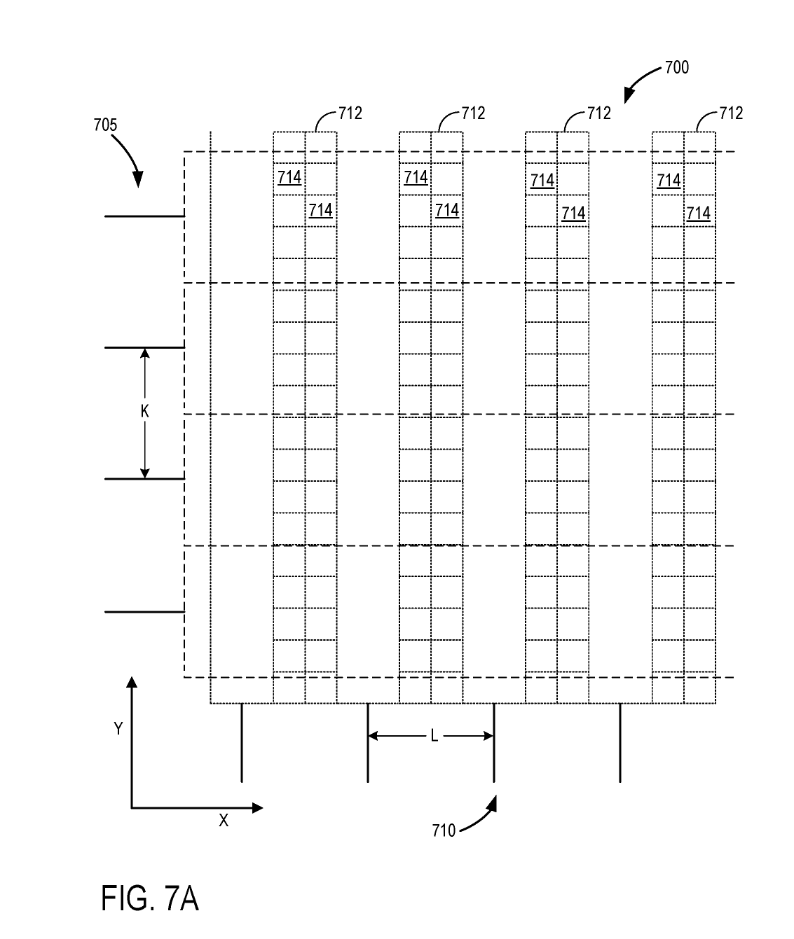

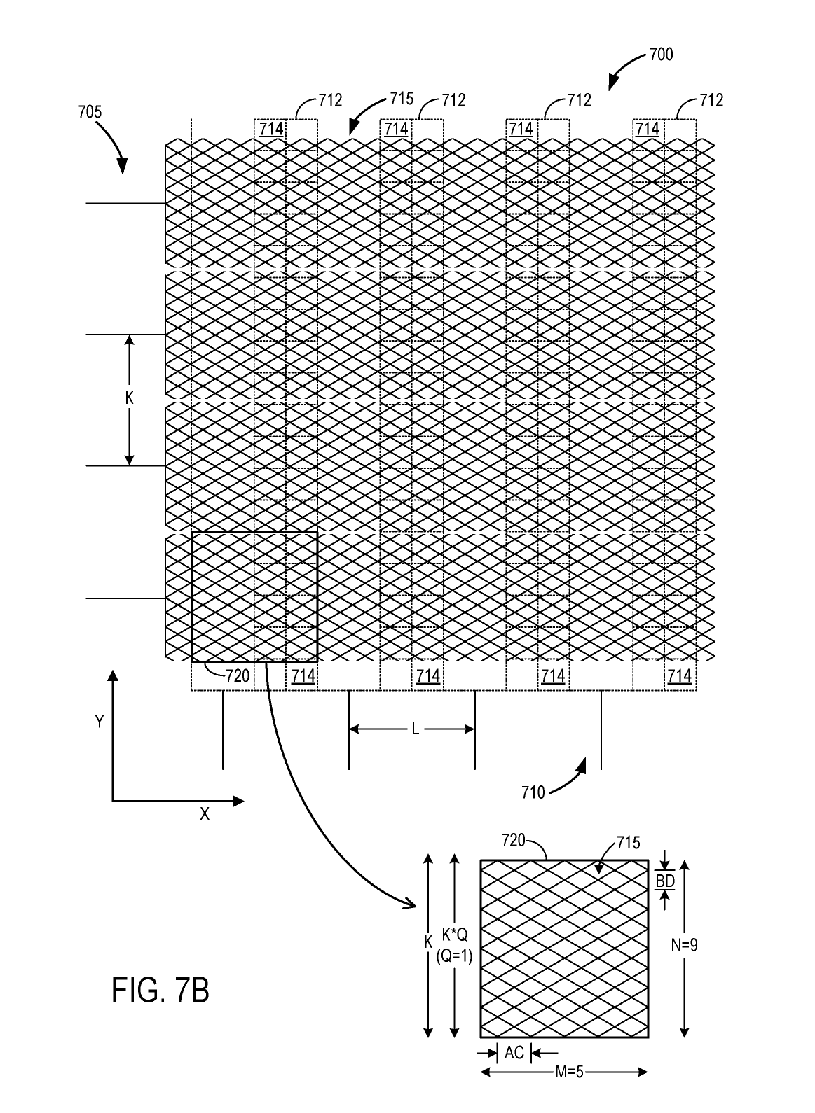

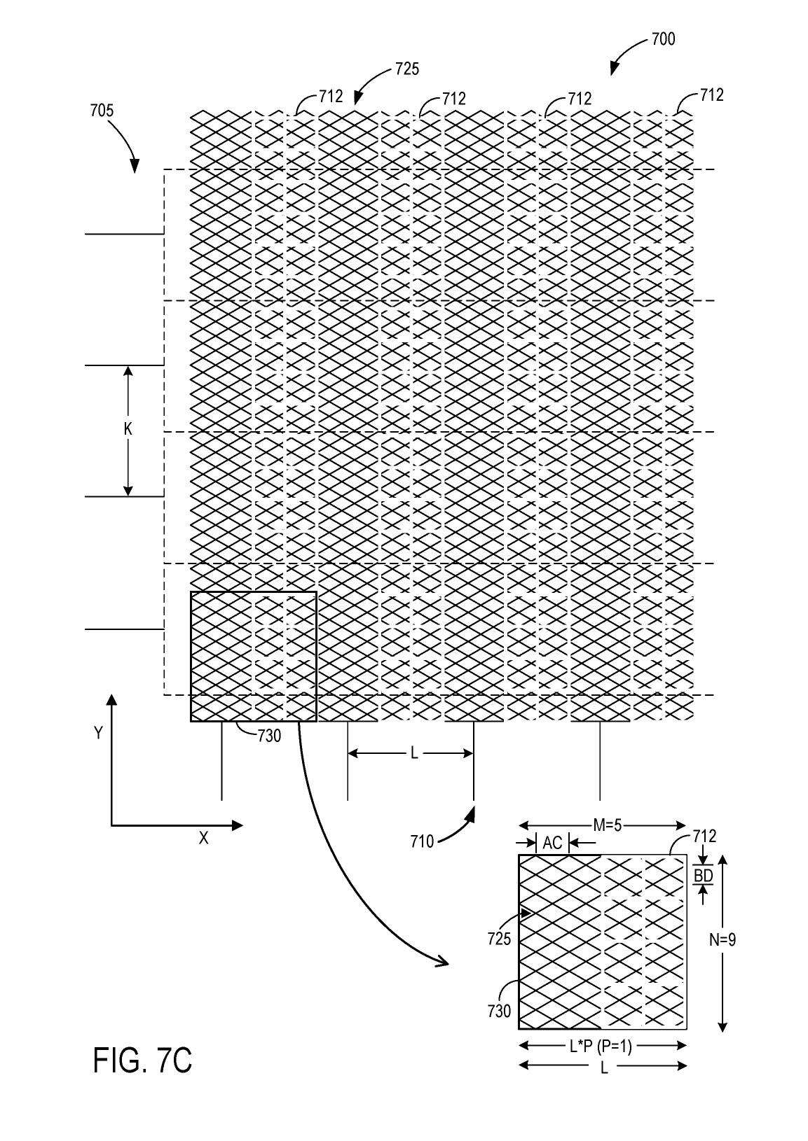

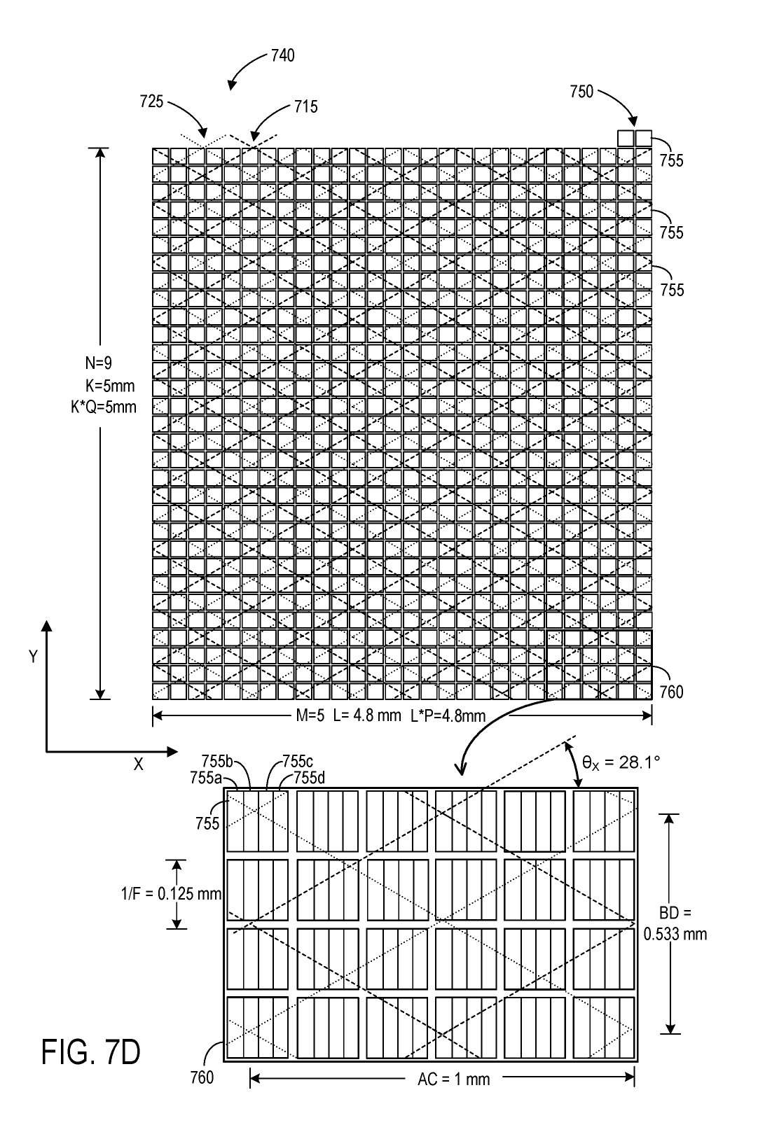

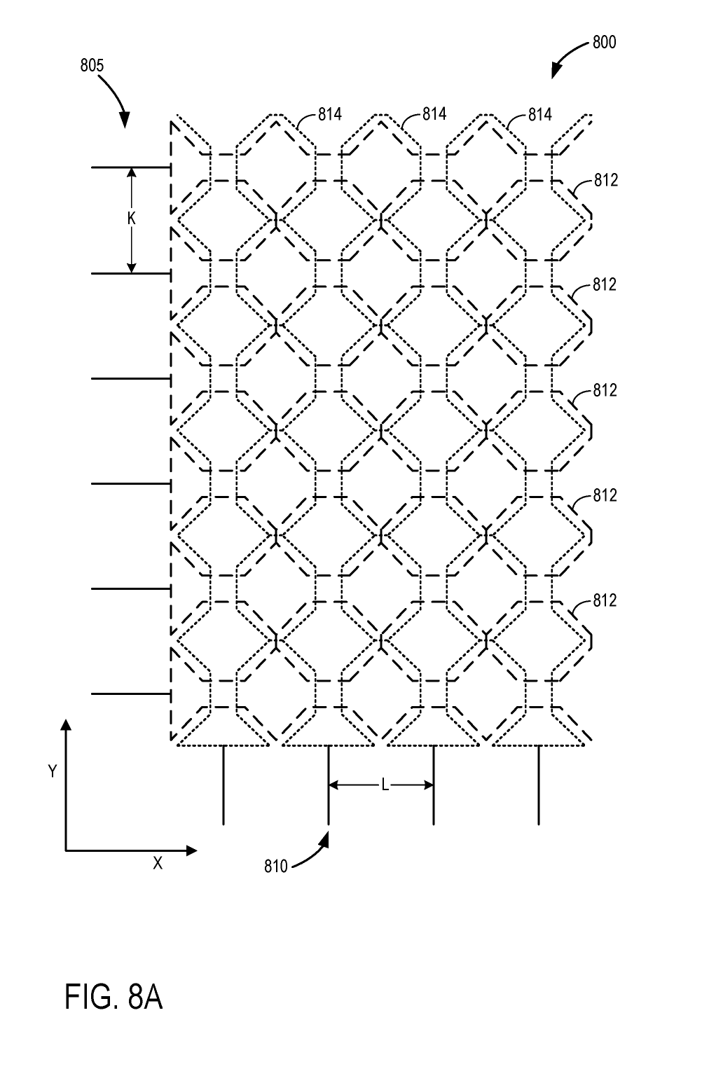

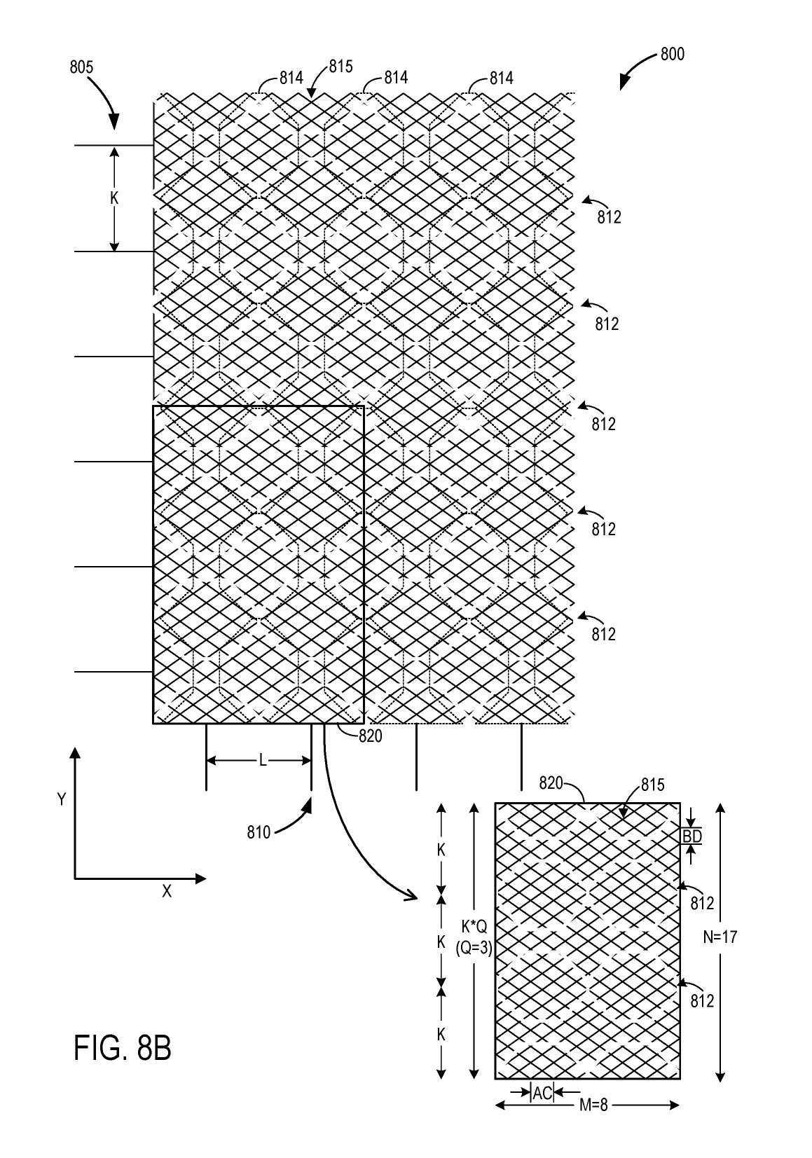

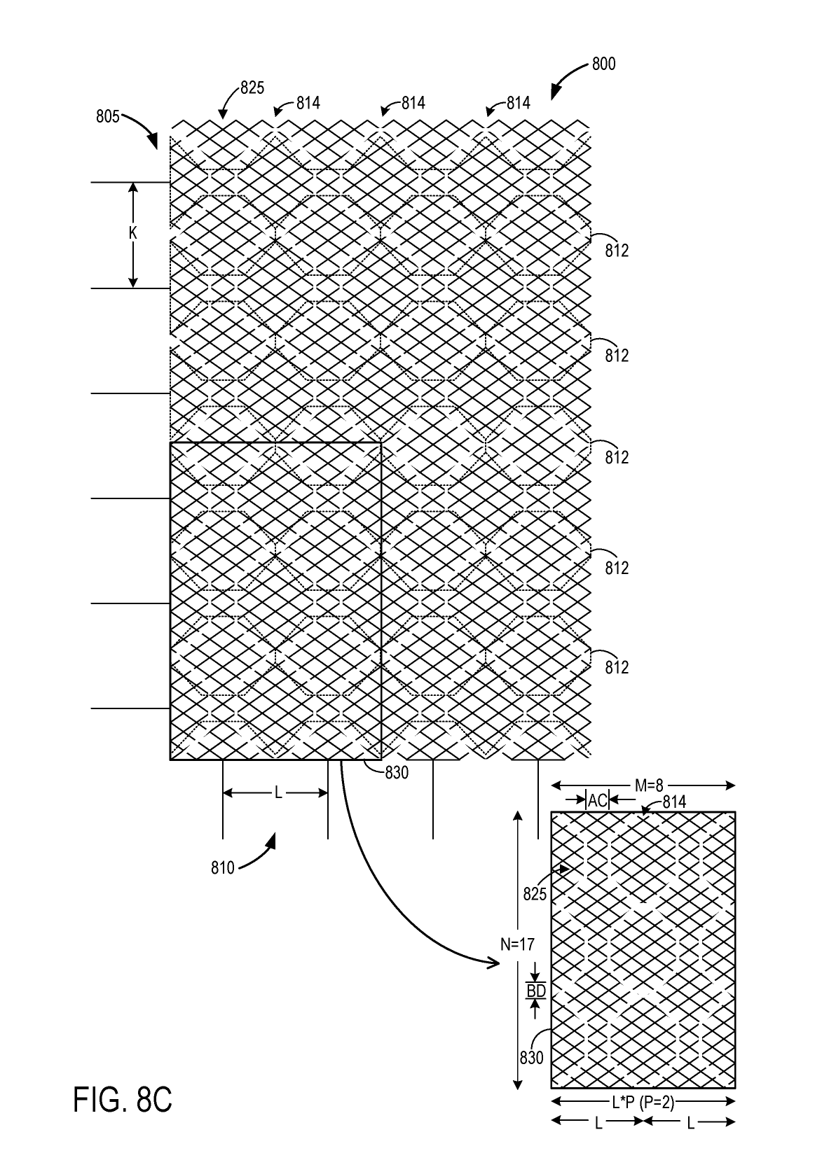

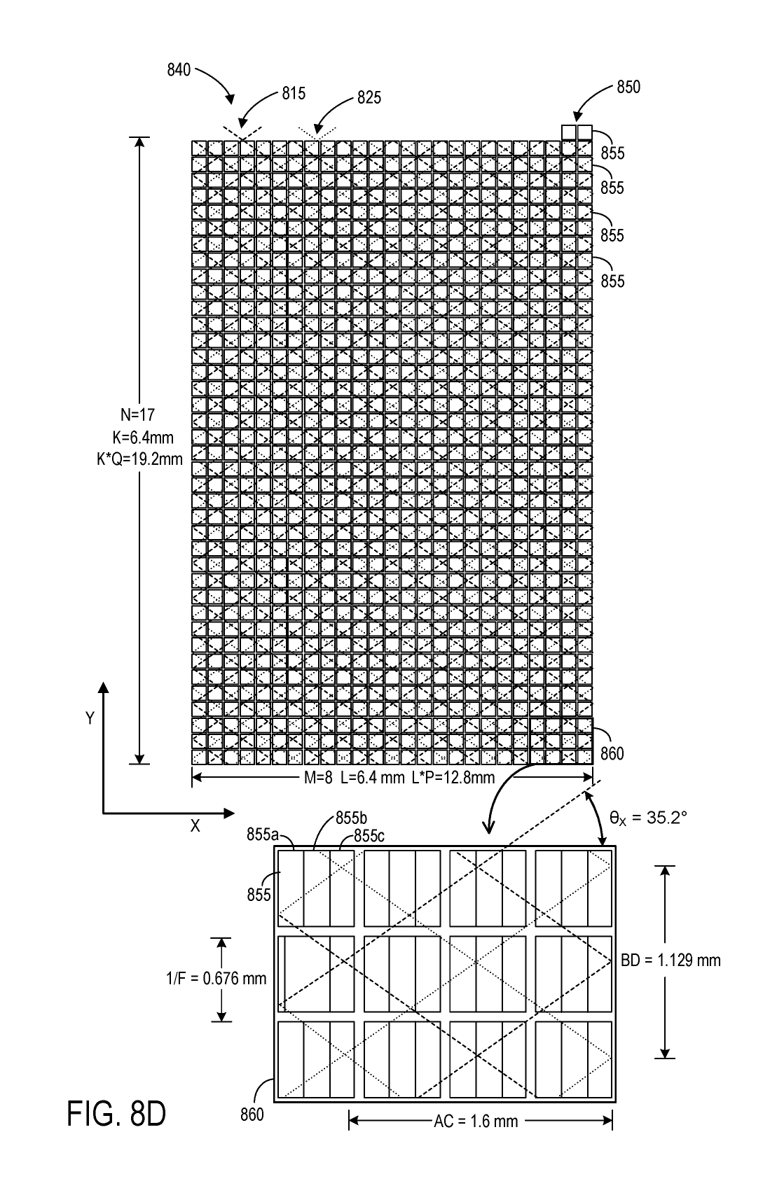

In some examples, such as the example shown in FIGS. 6A-6C, the mesh of each array is divided entirely into electrodes. In other examples, such as the examples shown in FIGS. 7A-7C and 8A-8C, the mesh is divided into both electrodes and inter-electrode regions, with each inter-electrode region being electrically isolated from all adjacent electrodes and all other inter-electrode regions.

Although the example electrode arrays presented herein are described with regard to large-format displays and/or displays requiring a relatively high number of electrodes per array, it should be understood that the relative geometric properties of such electrode arrays are equally applicable to small format displays, such as displays found in tablet computers and smart-phones, and/or displays where a relatively small number of electrodes per array are needed to generate desired degrees of touch sensitivity and accuracy. In such examples, the dimensions of the electrodes and electrode meshes may be scaled up or down, depending on the dimensions and applications of the electrode arrays.

To further simplify tooling for manufacturing electrodes, the electrode repeat lengths L*P and K*Q may comprise an integer number of mesh unit cells. For electrodes fabricated from a rhombic lattice mesh having unit cell ABCD, the repeat length may thus be equal to a number of unit cells such that L*P=AC*M and K*Q=BD*N, where M and N are integers. In some examples, an additional design constraint includes setting the electrode repeat lengths equal to the electrode pitches. For such an electrode matrix, P=Q=1, M=L/AC, and N=K/BD.

Electrode pitches are typically set in the range of ˜4-7 mm in order to best compromise between touch sensing spatial resolution, temporal resolution, and sensitivity, while conductor spatial frequency (G) is typically in the range of ˜1-2.5 mm¹, in order to best compromise between optical transmission, fine visual texture, and electrical redundancy. In such an example, M and N are thus roughly in the ranges of ˜2-13 and ˜3-17, respectively. In some examples, M is preferentially in the range of 4-13, and more preferentially in the range of 4-10. Similarly, in some examples, N is preferentially in the range of 7-17 and more preferentially in the range of 7-13. While the example electrodes presented herein fall within these sizing parameters, it should be noted that the geometric relationships within the mesh, and between the mesh and electrodes, are equally applicable to electrodes and conductors that have differing dimensions from these examples.

As such, the goal of having a uniform rhombic electrode matrix tends to conflict with the goal of minimizing moiré band pitch and optical contrast. Most combinations of M and N within the practical ranges of their values result in strong moiré interactions between the rhombic mesh and the display pixels, as M and N are preferably small integers, and M/N must not equal 1/8, 1/7 1/6, 1/5, 1/4, 1/3, 2/5, 1/2, 3/5, 2/3, 3/4, 4/5, or 1.

One solution to this problem is to make K and L dissimilar, so that tan(θ_{X})≠(M/N). However, because significant moiré interactions occur throughout an extended region around each singularity in the {F/(G*cos θ_{X}), tan(θ_{X})} parameter space, this solution practically requires that K and L differ by at least several percent. This can create an objectionable difference in touch sensing resolution along the X and Y axes.

To provide a geometric relationship between the electrode boundaries and the mesh that repeats exactly over a small-integer number of electrodes, the unit cell ABCD must meet both parameters 1 and 2 below. To additionally minimize the visibility of moiré interactions with a particular display device, parameter 3 must also be met.
1. AC is equal to L*P/M, here M and P are integers.
2. BD is equal to K*Q/N, where N and Q are integers.
3. The lesser of ((K*M*Q)/(L*N*P)) and ((L*N*P)/(K*M*Q)) is greater than 0.5, less than 0.8, and not equal to 0.6, 2/3, or 0.75.

The ratios ((K*M*Q)/(L*N*P)) and ((L*N*P)/(K*M*Q)) express the ratio between the length of major axis AC and the length of major axis BD, and thus may be derived from values of θ_{X} which are shown to limit moirés for a given pixel array configuration. As such, rhombic unit cells where AC=BD (e.g., squares) violate parameter 3, as ((K*M*Q)/(L*N*P)) and ((L*N*P)/(K*M*Q))=1

As an example, electrode matrix 600 may be configured to be applied to a LCD display having pixels arrayed with a square unit cell of pitch 0.37 mm and thus a spatial frequency of F≈2.35 mm⁻¹, though it should be noted that similar electrode matrixes may be configured for use with different display types, display dimensions, pixel types, and pixel dimensions without departing from the scope of this disclosure. It was empirically determined that moirés between an electrode array and such a pixel array are least perceptible with a mesh having an opening angle of θ_{X}=35˜36° and F/(G*cos θ_{X})=1.1˜1.2. As tan θ_{X}=(BD/AC), a rhombic lattice mesh must then comprise a unit cell where the major axis AC is approximately 1.377˜1.428 fold longer than minor axis BD in order to reduce moiré effects for this example touch-sensing display.

Returning to FIG. 6A, an example electrode matrix of the current disclosure is depicted comprising first array of electrodes 605 having an electrode pitch of K as well as second array of electrodes 610 having an electrode pitch of L, and where K=L. In this matrix, P=Q=1 (e.g., the electrode repeat length of each array is equal to one electrode pitch), and electrodes fill the entire matrix area such that there are no electrically floating inter-electrode regions.

FIGS. 6B and 6C show example electrode arrays that conform to the parameters of θ_{X} described for the example display with a pixel spatial frequency of F≈2.35 mm⁻¹. FIG. 6B depicts electrodes of first array 605 comprising a rhombic lattice mesh 615. As an example, rhombic lattice mesh 615 may comprise a rhombic lattice mesh of 0.01 mm wide conductors, divided into electrodes by 0.1 mm gaps. As an example, the conductors may be silver, and the two arrays may be fabricated by a silver-halide photographic process on opposite sides of a single 0.125 mm thick polyethylene terephthalate film substrate.

Rhombic lattice mesh 615 is shown in more detail in inset 620. Therein, the unit cell ABCD is shown to be periodic along X with a repeat of M=5 and periodic along Y with a repeat of N=7. Similarly, FIG. 6C depicts second array of electrodes 610 comprising rhombic lattice mesh 625, which is identical to rhombic lattice mesh 615, and shown in more detail in inset 630.

FIG. 6D schematically depicts a detailed view of a portion of a rhombic electrode matrix 640 comprising rhombic lattice mesh 615 (dashed lines) arranged interstitially with rhombic lattice mesh 625 (dotted lines). Rhombic electrode matrix 640 is overlaid on a pixel array 650. Pixel array 650 comprises pixels 655 arrayed with a square unit cell of pitch 0.37 mm and thus a spatial frequency of F≈2.35 mm⁻¹. Each pixel 655 comprises one red sub-pixel 655a, one green sub-pixel 655b, and one blue sub-pixel 655c.

Using values of M=5, N=7, and P=Q=1, as shown in FIGS. 6B and 6C, as well as values of K=L=6 mm, yields values of θ_{X}≈35.5°, AC=1.2 mm, and BD≈0.857 mm, as shown in inset 660. For the superposition of rhombic lattice mesh 615 onto rhombic lattice mesh 625, the apparent conductor spatial frequency G is approximately 2.87 mm⁻¹, and F/(G*cos θ_{X})≈1.16. This electrode matrix thus satisfies each of the three geometric parameters described herein. AC=L*P/M (1.2 mm=6 mm*1/5); BD=K*Q/N (0.857 mm=6 mm/); and (K*M*Q/L*N*P) is greater than 0.5, less than 0.8, and not equal to 0.6, 2/3, or 0.75 (6 mm*5*1/6 mm*7*1=0.7143).

A second example electrode matrix of the current disclosure is depicted in FIG. 7A. FIG. 7A schematically shows an example electrode matrix 700, comprising a first array of electrodes 705 and a second array of electrodes 710. Four electrodes are shown as representative electrodes of each array out of the plurality of electrodes that make up electrode matrix 700. Electrodes of first array 705 extend along the X direction, and are arrayed along the Y direction on pitch K with a repeating pattern of Q electrodes. Electrodes of second array 710 extend along the Y direction, and are arrayed along the X direction on pitch L with a repeating pattern of P electrodes. Adjacent electrodes of first array 705 are electrically isolated via gaps (dashed lines). Adjacent electrodes of second array 710 are separated by inter-electrode alleys 712, comprising multiple electrically floating inter-electrode regions 714. Inter-electrode regions 714 are depicted as having an approximately square shape, however other shapes and configurations may be used. Electrode pitch L encompasses the length of an electrode plus the length of an adjacent inter-electrode alley. In this example, K=(25/24)*L, and P=Q=1. In other words, the two arrays have an identical repeat length, but differ slightly in electrode pitch.

As an example, electrode matrix 700 may be configured to be applied to a WOLED display having pixels arrayed with a square unit cell of pitch 0.125 mm and thus a spatial frequency of F=8 mm⁻¹, though it should be noted that similar electrode matrixes may be configured for use with different display types, display dimensions, pixel types, and pixel dimensions without departing from the scope of this disclosure. It was determined via a ray-tracing simulation that moirés between an electrode array and such a pixel array are least perceptible with a mesh having an opening angle of θ_{X}=27.5˜29° and F/(G*cos θ_{X})=2.05˜2.15. A rhombic lattice mesh must then comprise a unit cell where the major axis AC is approximately 1.804-1.921 fold longer than minor axis BD in order to reduce moiré effects for this example touch-sensing display.

FIGS. 7B at 7C show example electrode arrays that confirm to the parameters of θ_{X} described for the example display with a pixel spatial frequency of F≈8 mm⁻¹. FIG. 7B depicts electrodes of first array 705 comprising a rhombic lattice mesh 715. As an example, rhombic lattice mesh 715 may comprise a rhombic lattice mesh of 0.1 mm wide conductors, divided into electrodes by 0.1 mm gaps. As an example, the conductors may be copper, and the two arrays may be fabricated by photo-etching an initially continuous plane of copper on either side of a 0.05 mm thick cyclic olefin polymer film substrate.

Rhombic lattice mesh 715 is shown in more detail in inset 720. Therein, the unit cell ABCD is shown to be periodic along X with a repeat of M=5 and along Y with a repeat of N=9. Similarly, FIG. 7C depicts electrodes of second array 710 comprising rhombic lattice mesh 725, which is geometrically identical to rhombic lattice mesh 715, and shown in more detail in inset 730. Rhombic lattice mesh 725 is geometrically contiguous across second array of electrodes 710, including within inter-electrode alleys 712. However, the portions of rhombic lattice mesh 725 within inter-electrode alleys 712 are electrically discontinuous, thereby electrically isolating adjacent electrodes.

FIG. 7D schematically depicts a detailed view of a portion of rhombic lattice meshes 715 and 725 arranged interstitially and overlaid on a pixel may 750. Pixel array 750 comprises pixels arrayed with a square unit cell of pitch 0.125 mm and thus a spatial frequency of F≈8 mm⁻¹. Each pixel 775 comprises one red sub-pixel 755a, one green sub-pixel 755b, one blue sub-pixel 755c, and one white sub-pixel 755d.

Using values of M=5, N=9, and P=Q=1, as shown in FIGS. 7B and 7C, as well as values of K=5 mm and L=4.8 mm, yields values of θ_{X}≈28.1°, AC=1 mm, and BD≈0.533 mm as shown in inset 760. For the superposition of rhombic lattice mesh 715 onto rhombic lattice mesh 725, the apparent conductor spatial frequency G is approximately 4.25 mm⁻¹, and F/(G*cos θ_{X})≈2.133. This electrode matrix thus satisfies each of the three geometric parameters described herein. AC=L*P/M (1 mm=5 mm*1/5); BD=K*Q/N (0.533 mm=4.8 mm/9); and (K*M*Q/L*N*P) is greater than 0.5, less than 0.8, and not equal to 0.6, 2/3, or 0.75 (5 mm*5*1/4.8 mm*9*1=0.5787).

A third example electrode matrix of the current disclosure is depicted in FIG. 8A. FIG. 8A schematically shows an example electrode matrix 800, comprising a first array of electrodes 805 and a second array of electrodes 810. Six electrodes of first array 805 and four electrodes of second array 810 are shown as representative electrodes out of the plurality of electrodes that make up electrode matrix 800. Electrodes of first array 805 extend along the X direction, and are arrayed along the Y direction on pitch K with a repeating pattern of Q electrodes. Electrodes of second array 810 extend along the Y direction, and are arrayed along the X direction on pitch L with a repeating pattern of P electrodes. Electrodes of both first array 805 and second array 810 have a linked-diamond shape and are separated by electrically floating inter-electrode regions 812 and 814, respectively. Inter electrode regions 812 and 814 are depicted as having an octagonal shape, though other shapes and configurations may be used. In this example, K=L, P=2, and Q=3. In other words, the two arrays have an identical electrode pitch, but differ in repeat length.

As an example, electrode matrix 800 may be configured to be applied to a plasma display having pixels arrayed with a square unit cell of pitch 0.676 mm and thus a spatial frequency of F≈1.48 mm⁻¹, though it should be noted that similar electrode matrixes may be configured for use with different display types, display dimensions, pixel types, and pixel dimensions without departing from the scope of this disclosure. It was empirically determined that moirés between an electrode array and such a pixel array are least perceptible with a mesh having an opening angle of θ_{X}=34˜35° and F/(G*cos θ_{X})=0.8˜0.85. A rhombic lattice mesh must then comprise a unit cell where the major axis AC is approximately 1.428˜1.483 fold longer than minor axis BD in order to reduce moiré effects for this example touch-sensing display.

FIGS. 8B and 8C show example electrode arrays that conform to the parameters of θ_{X} described for the example display with a pixel spatial frequency of F≈1.48 mm⁻¹. FIG. 8B depicts first array of electrodes 805 comprising a rhombic lattice mesh 815. As an example, rhombic lattice mesh 815 may comprise a rhombic lattice mesh of 0.01 mm wide conductors, divided into electrodes by 0.1 mm gaps. As an example, the conductors may be silver, and the two arrays may be fabricated by embossing grooves to a 0.05 mm thick polyethylene terephthalate) film, filling in the grooves with silver nanoparticle ink, UV curing the ink, and thermally sintering the silver.

Rhombic lattice mesh 815 is shown in more detail in inset 820. Therein, the cell ABCD is shown to be periodic along X with a repeat of M=8 and along Y with a repeat of N=17. Similarly, FIG. 8C depicts second array of electrodes 810 comprising rhombic lattice mesh 825, which is identical to rhombic lattice mesh 815, and shown ore detail in inset 830.

FIG. 8D schematically depicts a detailed view of a portion of rhombic lattice meshes 815 and 825 arranged interstitially and overlaid on a pixel array 850. As per rhombic lattice mesh 725, rhombic lattice meshes 815 and 825 are geometrically contiguous across their respective arrays, including within inter-electrode regions 812 and 814, respectively. However, the portions of rhombic lattice meshes 815 and 825 within inter-electrode regions 812 and 814 are electrically discontinuous from the rhombic lattice mesh within first array of electrodes 805 and second array of electrodes 810, thereby electrically isolating adjacent electrodes. Pixel array 850 comprises pixels arrayed with a square unit cell of pitch 0.676 mm and thus a spatial frequency of F≈1.48 mm⁻¹. Each pixel 855 comprises one red sub-pixel 855a, one green sub-pixel 855b, and one blue sub-pixel 855c.

Using values of M=8, N=17, P=2, and Q=3, as shown in FIGS. 8B and 8C, as well as values of K=L=6.4 mm, yields values of θ_{X}≈35.2°, AC=1.6 mm, and BD≈1.129 mm, as shown in inset 860. For the superposition of rhombic lattice mesh 815 onto rhombic lattice mesh 825, the apparent conductor spatial frequency G is approximately 2.17 mm⁻¹, and F/(G*cos θ_{X})≈0.817. This electrode matrix thus satisfies each of the three geometric parameters described herein. AC=L*P/M (1.6 mm=6.4 mm*2/8); BD=K*Q/N (1.129 mm=6.4 mm*3/17); and (K*M*Q/L*N*P) is greater than 0.5, less than 0.8, and not equal to 0.6, 2/3, or 0.75 (6.4 mm*8*3/6.4 mm*17*2=0.7059).

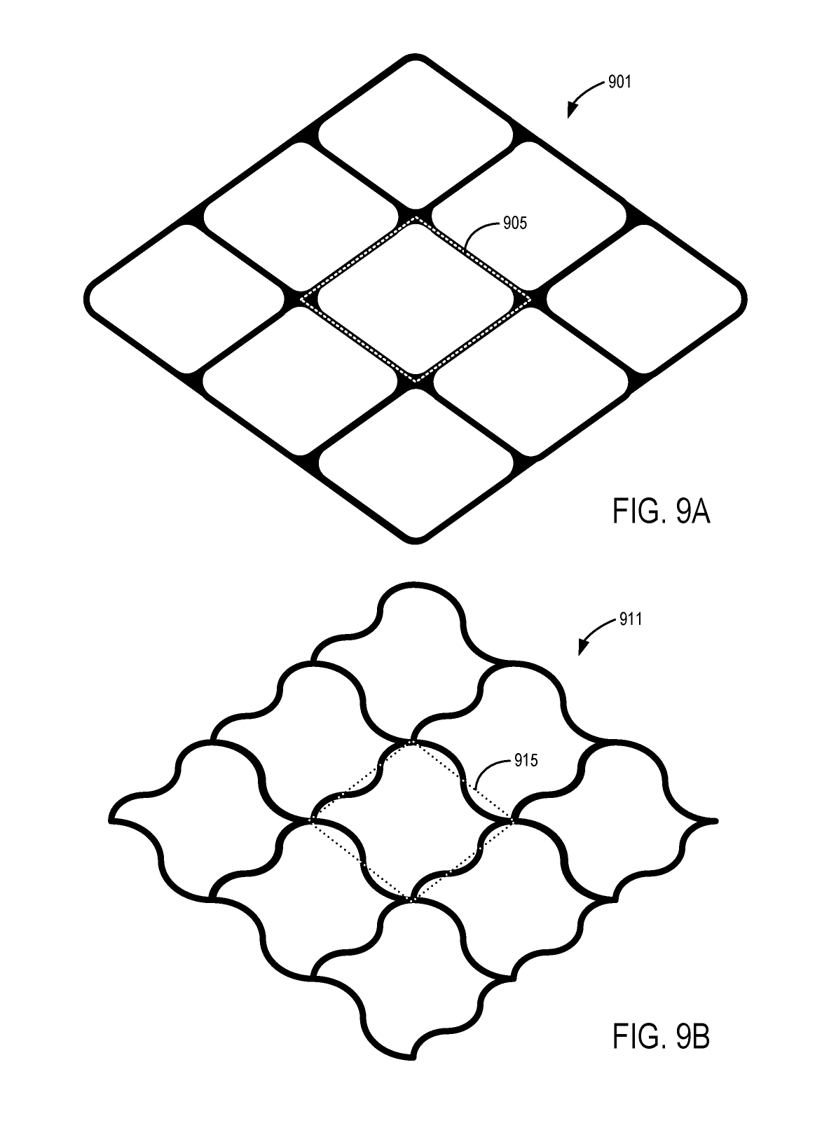

While the examples depicted in FIGS. 4, 5A-5B, 6A-6D, 7A-7D, and 8A-8D show a rhombic lattice mesh having both a rhombic unit cell and rhombic mesh openings, the latter is not necessary to achieve the technical effects of utilizing rhombic lattice meshes in the two layers of an electrode matrix. FIGS. 9A and 9B show additional examples of rhombic lattice meshes having a rhombic unit cell, but that do not have rhombic mesh openings. FIG. 9A schematically shows a portion of an example mesh 901 comprising a rhombic unit cell 905 and having mesh openings with rounded vertices. FIG. 9B schematically shows a portion of an example mesh 911 comprising a rhombic unit cell 915 having mesh openings with a curvilinear shape. The parameters for electrode matrixes presented herein are equally applicable to a mesh having openings of any shape, provided the unit cell of the mesh is rhombic. In some examples, an electrode matrix may comprise first and second rhombic lattice meshes, wherein both rhombic lattice meshes have identical unit cells, but the mesh openings of the first rhombic lattice mesh are different from the mesh openings of the second rhombic lattice mesh.

FIG. 10 illustrates an exemplary image source S according to one embodiment of the present invention. As discussed above, image source S may be an external computing device, such as a server, laptop computing device, set top box, game console, desktop computer, tablet computing device, mobile telephone, or other suitable computing device. Alternatively, image source S may be integrated within display device 100.

Image source S includes a processor, volatile memory, and non-volatile memory, such as mass storage, which is configured to store software programs in a non-volatile manner. The stored programs are executed by the processor using portions of volatile memory. Input for the programs may be received via a variety of user input devices, including touch 208 integrated with capacitive touch-sensing display 108 of display device 100. The input may be processed by the programs, and suitable graphical output may be sent to display device 100 via a display interface for display to a user.

The processor, volatile memory, and non-volatile memory may be formed of separate components, may be integrated into a system on a chip, for example. Further the processor may be a central processing unit, a multi-core processor, an ASIC, system-on-chip, or other type of processor. In some embodiments, aspects of the processor, volatile memory and non-volatile memory may be integrated into devices such as field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

A communications interface may also be provided to communicate with other computing devices, such as servers, across local and wide area network connections, such as the Internet.

The non-volatile memory may include removable media and/or built-in devices. For example, non-volatile memory may include optical memory devices (e.g., CD, DVD, HD-DVD Blu-Ray Disc, etc.), semiconductor memory devices (e.g., FLASH, EPROM, EEPROM, etc.) and/or magnetic memory devices (e.g., hard disk drive, floppy disk drive, tape drive, MRAM, etc.), among others.

Removable computer readable storage media (CRSM) may be provided, which may be used to store data and/or instructions executable to implement the methods and processes described herein. Removable computer-readable storage media may take the form of CDs, DVDs, HD-DVDs, Blu-Ray Discs, EEPROMs, and/or floppy disks, among others.

Although the non-volatile memory and CRSM are physical devices configured to hold instructions for a duration of time, typically even upon power down of the image source, in some embodiments, aspects of the instructions described herein may be propagated by a computer readable communication medium, such as the illustrated communications bus, in a transitory fashion by a pure signal (e.g., an electromagnetic signal, an optical signal, etc.) that is not held by a physical device for at least a finite duration.

The term “program” may be used to describe software firmware, etc. of the system that is implemented to perform one or more particular functions. In some cases, such a program may be instantiated via the processor executing instructions held by non-volatile memory, using portions of volatile memory. It is to be understood that different programs may be instantiated from the same application, service, code block, object, library, routine, function, etc. Likewise, the same program may be instantiated by different applications, services, code blocks, objects, routines, APIs, functions, etc. The term “program” is meant to encompass individual or groups of executable files, data files, libraries, drivers, scripts, database records, etc.

The systems and methods described herein and with regard to FIGS. 1-10 may enable one or more methods and one or more systems. In one example, an electrode matrix is provided, comprising: a first array of electrodes comprising a periodic mesh of opaque electrically conductive material, the mesh divided into a plurality of first electrodes extending along a first direction X, the first electrodes arrayed at a pitch K along a second direction Y, orthogonal to X, and having a repeating pattern of Q electrodes; a second array of electrodes comprising a periodic mesh of opaque electrically conductive material, the mesh divided into a plurality of second electrodes extending along Y, the second electrodes arrayed at a pitch L along X and having a repeating pattern of P electrodes, and wherein: each periodic mesh of opaque electrically conductive material comprises a rhombic lattice mesh having unit cell ABCD, wherein a diagonal AC is parallel to X and a diagonal BD is parallel to Y; unit cell ABCD is repeated N times along Y over each electrode repeat length K*Q such that BD has a length equal to K*Q/N, where Q and N are integers; unit cell ABCD is repeated M times along X over each electrode repeat length L*P such that AC has a length equal to L*P/M, where P and M are integers; and the first and second arrays of electrodes are relatively positioned on opposite sides of a transparent electrical insulator such that, when viewed from a direction normal to XY so that the first array of electrodes is superimposed on the second array of electrodes, each vertex of each unit cell of the first array of electrodes is closer to a center of an underlying unit cell of the second array of electrodes than to any vertex of that underlying unit cell. In such an example electrode matrix, M may additionally or alternatively be an integer such that 4≦M≦13, and N may additionally or alternatively be an integer such that 7≦N≦17. In such an example electrode matrix, M may additionally or alternatively be an integer such that 4≦M≦10, and N may additionally or alternatively be an integer such that 7≦N≦13. In such an example electrode matrix, either or both of P and Q may additionally or alternatively be less than or equal to 16. In such an example electrode matrix, either or both of P and Q may additionally or alternatively be less than or equal to 4. In such an example electrode matrix, both P and Q may additionally or alternatively be equal to 1. In such an example electrode matrix, min{((K*M*Q)/(L*N*P)); ((L*N*P))/(K*M*Q))} may additionally or alternatively be greater than 0.5, less than 0.8, and not equal to 3/5, 2/3, or 3/4. In such an example electrode matrix, one or both of the first array of electrodes and second array of electrodes may additionally or alternatively comprise inter-electrode regions that are electrically discontinuous from adjacent electrodes, the inter-electrode regions filled with an opaque mesh having a unit cell ABCD aligned with the meshes of the electrodes. In such an example electrode matrix, the primary and secondary electrodes may additionally or alternatively be concave polygonal in shape. In such an example electrode matrix, the primary and secondary electrodes may additionally or alternatively be linked-diamond type electrodes. In such example electrode matrix, the transparent electric insulator may additionally or alternatively be a substrate for both the first array of electrodes and the second array of electrodes. In such an example electrode matrix, the first and second arrays of electrodes may additionally or alternatively be relatively positioned on opposite sides of the transparent electrical insulator such that, when viewed from a direction normal to XY so that the first array of electrodes is superimposed on the second array of electrodes, the apparent distance between each vertex of the unit cells of the first array of electrodes and a center of an underlying unit cell of the second array of electrodes is less than one-half of a radius of a circle inscribing the underlying unit cell. In such an example electrode matrix, the first and second arrays of electrodes may additionally or alternatively be relatively positioned on opposite sides of the transparent electrical insulator such that, when viewed from a direction normal to XY so that the first array of electrodes is superimposed on the second array of electrodes, each vertex of each unit cell of the first array of electrodes is coincident with a center of an underlying unit cell of the second array of electrodes. Any or all of the above-described example electrode matrixes may be combined in any suitable manner in various implementations.

In another example, a capacitive touch sensor is provided, comprising: an optically clear touch sheet; a first array of electrodes comprising a periodic mesh of opaque electrically conductive material, the mesh divided into a plurality of first electrodes extending along a first direction X, the first electrodes arrayed at a pitch K along a second direction Y, orthogonal to X, and having a repeating pattern of Q electrodes; one or more time varying voltage sources to successively drive each of the first electrodes; a second array of electrodes comprising a periodic mesh of opaque electrically conductive material, the mesh divided into a plurality of second electrodes extending along Y, the second electrodes arrayed at a pitch L along X and having a repeating pattern of P electrodes, the second electrodes electrically coupled to ground and to one or more current-sensitive detection circuits, and wherein: each of the first electrodes and second electrodes are electrically coupled to one or more of a time varying voltage source and a current-sensitive detection circuit; each periodic mesh of opaque electrically conductive material comprises a rhombic lattice mesh having a unit cell ABCD, wherein a major diagonal AC is parallel to X and a minor diagonal BD is parallel to Y; unit cell ABCD is repeated N times along Y over each electrode repeat length K*Q such that BD has a length equal to K*Q/N, where Q is an integer less than or equal to 4, and N is an integer between 7 and 13, inclusive; unit cell ABCD is repeated M times along X over each electrode repeat length L*P such that AC has a length equal to L*P/M, where P is an integer less than or equal to 4, and M is an integer between 4 and 10, inclusive; ((L*N*P)/(K*M*Q)) is greater than 0.5, less than 0.8, and not equal to 3/5, 2/3, or 3/4; and the first and second arrays of electrodes are relatively positioned on opposite sides of a transparent, electrically insulating substrate such that when viewed from a direction normal to XY, so that the first array of electrodes is superimposed on the second array of electrodes, each vertex of each unit cell of the first array of electrodes is closer to a center of an underlying unit cell of the second array of electrodes than to any vertex of that underlying unit cell. In such an example capacitive touch sensor, both P and Q may additionally or alternatively be equal to 1. Any or all of the above-described example capacitive touch sensors may be combined in any suitable manner in various implementations.

In yet another example, a touch-sensing display device is provided, comprising: a display device having an array of pixels that is periodic along a first direction X and along a second direction Y; a first array of electrodes comprising a periodic mesh of opaque electrically conductive material, the mesh divided into a plurality of first electrodes extending along X, the first electrodes arrayed at a pitch K along Y having a repeat pattern of Q electrodes, and wherein: the periodic mesh of opaque electrically conductive material comprises a rhombic lattice mesh having a unit cell ABCD, wherein a diagonal AC is parallel to X and a diagonal BD is parallel to Y; arctan(BD/AC)=θ_{X}, such that tan (θ_{X}) is greater than 0.5, less than 0.8, and not equal to 3/5, 2/3, or 314; and Q is an integer that is less than or equal to 16. Such an example touch-sensing display device may additionally or alternatively comprise a second array of electrodes comprising a periodic mesh of opaque electrically conductive material, the mesh having a unit cell that is congruent to the unit cell of the rhombic lattice mesh of the first array of electrodes, and divided into a plurality of second electrodes extending along Y, the second electrodes arrayed at a pitch L along X and having a repeat length of P electrodes, and wherein: unit cell ABCD is repeated N times along Y over each electrode repeat length K*Q, such that BD has a length equal to K*Q/N, where Q and N are integers; unit cell ABCD is repeated M times along X over each electrode repeat length L*P, such that AC has a length equal to L*P/M, where P and M are integers; the first and second arrays of electrodes are relatively positioned on opposite sides of a transparent electrical insulator such that when viewed from a direction normal to XY such that the first array of electrodes is superimposed on the second array of electrodes, each vertex of each unit cell of the first array of electrodes is closer to a center of an underlying unit cell of the second array of electrodes than to any vertex of that underlying unit cell. In such an example touch-sensing display device, P may additionally or alternatively be less than or equal to 16. In such an example touch-sensing display device, M may additionally or alternatively be an integer such that 4≦M≦10, and N may additionally or alternatively be an integer such that 7≦N≦13. In such an example touch-sensing display device, each display pixel may additionally or alternatively comprise a plurality of primary-colored subpixels. Any or all of the above-described example touch-sensing display devices may be combined in any suitable manner in various implementations.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An electrode matrix, comprising:
a first array of electrodes comprising a periodic mesh of opaque electrically conductive material, the mesh divided into a plurality of first electrodes extending along a first direction X, the first electrodes arrayed at a pitch K along a second direction Y, orthogonal to X, and having a repeating pattern of Q electrodes;
a second array of electrodes comprising a periodic mesh of opaque electrically conductive material, the mesh divided into a plurality of second electrodes extending along Y, the second electrodes arrayed at a pitch L along X and having a repeating pattern of P electrodes, and wherein:
each periodic mesh of opaque electrically conductive material comprises a rhombic lattice mesh having a unit cell ABCD, wherein a diagonal AC is parallel to X and a diagonal BD is parallel to Y;
unit cell ABCD is repeated N times along Y over each electrode repeat length K*Q such that BD has a length equal to K*Q/N, where Q and N are integers;
unit cell ABCD is repeated M times along X over each electrode repeat length L*P such that AC has a length equal to L*P/M, where P and M are integers; and
the first and second arrays of electrodes are relatively positioned on opposite sides of a transparent electrical insulator such that, when viewed from a direction normal to XY so that the first array of electrodes is superimposed on the second array of electrodes, each vertex of each unit cell of the first array of electrodes is closer to a center of an underlying unit cell of the second array of electrodes than to any vertex of that underlying unit cell.

2. The electrode matrix of claim 1, wherein 4≦M≦13 and 7≦N≦17.

3. The electrode matrix of claim 2, wherein 4≦M≦10 and 7≦N≦13.

4. The electrode matrix of claim 1, wherein either or both of P and Q are less than or equal to 16.

5. The electrode matrix of claim 4, wherein either or both of P and Q are less than or equal to 4.

6. The electrode matrix of claim 5, wherein P=Q=1.

7. The electrode matrix of claim 1, wherein min{((K*M*Q)/(L*N*P)); ((L*N*P))/(K*M*Q))} is greater than 0.5, less than 0.8, and not equal to 3/5, 2/3, or 3/4.

8. The electrode matrix of claim 1, wherein one or both of the first array of electrodes and second array of electrodes comprise inter-electrode regions that are electrically discontinuous from adjacent electrodes, the inter-electrode regions filled with an opaque mesh having a unit cell ABCD aligned with the meshes of the electrodes.

9. The electrode matrix of claim 8, wherein the primary and secondary electrodes are concave polygonal in shape.

10. The electrode matrix of claim 9, wherein the primary and secondary electrodes are linked-diamond type electrodes.

11. The electrode matrix of claim 1, wherein the transparent electric insulator is a substrate for both the first array of electrodes and the second array of electrodes.

12. The electrode matrix of claim 1, wherein the first and second arrays of electrodes are relatively positioned on opposite sides of the transparent electrical insulator such that, when viewed from a direction normal to XY so that the first array of electrodes is superimposed on the second array of electrodes, the apparent distance between each vertex of the unit cells of the first array of electrodes and a center of an underlying unit cell of the second array of electrodes is less than one-half of a radius of a circle inscribing the underlying unit cell.

13. The electrode matrix of claim 12, wherein the first and second arrays of electrodes are relatively positioned on opposite sides of the transparent electrical insulator such that, when viewed from a direction normal to XY so that the first array of electrodes is superimposed on the second array of electrodes, each vertex of each unit cell of the first array of electrodes is coincident with a center of an underlying unit cell of the second array of electrodes.

14. A capacitive touch sensor, comprising:
an optically clear touch sheet;
a first array of electrodes comprising a periodic mesh of opaque electrically conductive material, the mesh divided into a plurality of first electrodes extending along a first direction X, the first electrodes arrayed at a pitch K along a second direction Y, orthogonal to X, and having a repeating pattern of Q electrodes;
a second array of electrodes comprising a periodic mesh of opaque electrically conductive material, the mesh divided into a plurality of second electrodes extending along Y, the second electrodes arrayed at a pitch L along X and having a repeating pattern of P electrodes, and wherein:
each of the first electrodes and second electrodes are electrically coupled to one or more of a time varying voltage source and a current-sensitive detection circuit;
each periodic mesh of opaque electrically conductive material comprises a rhombic lattice mesh having a unit cell ABCD, wherein a major diagonal AC is parallel to X and a minor diagonal BD is parallel to Y;
unit cell ABCD is repeated N times along Y over each electrode repeat length K*Q such that BD has a length equal to K*Q/N, where Q is an integer less than or equal to 4, and N is an integer between 7 and 13, inclusive;
unit cell ABCD is repeated M times along X over each electrode repeat length L*P such that AC has a length equal to L*P/M, where P is an integer less than or equal to 4, and M is an integer between 4 and 13, inclusive;
((L*N*P)/(K*M*Q)) is greater than 0.5, less than 0.8, and not equal to 3/5, 2/3, or 3/4; and
the first and second arrays of electrodes are relatively positioned on opposite sides of a transparent, electrically insulating substrate such that when viewed from a direction normal to XY, so that the first array of electrodes is superimposed on the second array of electrodes, each vertex of each unit cell of the first array of electrodes is closer to a center of an underlying unit cell of the second array of electrodes than to any vertex of that underlying unit cell.

15. The capacitive touch sensor of claim 14, wherein P=Q=1.

16. A touch-sensing display device, comprising:
a display device having an array of pixels that is periodic along a first direction X and along a second direction Y;
a first array of electrodes comprising periodic mesh of opaque electrically conductive material, the mesh divided into a plurality of first electrodes extending along X, the first electrodes arrayed at a pitch K along Y having a pattern of Q electrodes, and wherein:
the periodic mesh of opaque electrically conductive material comprises a rhombic lattice mesh having a unit cell ABCD, wherein a diagonal AC is parallel to X and a diagonal BD is parallel to Y;
arctan (BD/AC)=θ_{X}, such that tan (θ_{X}) is greater than 0.5, less than 0.8, and not equal to 3/5, 2/3, or 3/4; and
Q is an integer that is less than or equal to 16.

17. The touch-sensing display device of claim 16, further comprising:
a second array of electrodes comprising a periodic mesh of opaque electrically conductive material, the mesh having a unit cell that is congruent to the unit cell of the rhombic lattice mesh of the first array of electrodes, and divided into plurality of second electrodes extending along Y, the second electrodes arrayed at a pitch L along X and having a repeat length of P electrodes, and wherein:
unit cell ABCD is repeated N times along Y over each electrode repeat length K*Q, such that BD has a length equal to K*Q/N, here N are integers;
unit cell ABCD is repeated M times along over each electrode repeat length L*P, such that AC has a length equal to L*P/M, where P and M are integers;
the first and second arrays of electrodes are relatively positioned on opposite sides of a transparent electrical insulator such that when viewed from a direction normal to XY such that the first array of electrodes is superimposed on the second array of electrodes, each vertex of each unit cell of the first array of electrodes is closer to a center of an underlying unit cell of the second array of electrodes than to any vertex of that underlying unit cell.

18. The touch-sensing display device of claim 17, wherein P is less than or equal to 16.

19. The touch-sensing display device of claim 17, wherein 4≦M≦10 and 7≦N≦13.

20. The touch-sensing display device of claim 16, wherein each display pixel comprises a plurality of primary-colored subpixels.
